(19) United States
(12) Patent Application Publication
(10) Pub. No.: US 2006/0209637 A1
(43) Pub. Date: Sep. 21, 2006

(54) Teaching/learning devices and display and presentation devices

(76) Inventors: Patrick May, Pasadena, CA (US); Gerald Karr, Venice, CA (US)

Correspondence Address: HENRICKS SLAVIN AND HOLMES LLP;SUITE 200, 840 APOLLO STREET, EL SEGUNDO, CA, 90245, US

(21) Appl. No.: 11/343,918

(22) Filed: Jan. 30, 2006

Related U.S. Application Data
(60) Provisional application No. 60/594,173, filed on Mar. 16, 2005.

(51) Int. Cl. G04C 17/00

(52) U.S. Cl. 368/223

(57) ABSTRACT

A clock or other display component has a user input to a controller configured to control a mechanical display unit, and it may also control a digital display unit. The controller controls the display unit(s) as a function of input from the user. User input can change the display in predefined increments, for example in the case of a clock in 5, 10, 15, 30 and 60 minute increments, or in other predefined increments greater than 1 minute. The user inputs can be on the back of the unit, leaving the front of unit freely visible. The clock, and also the separate mechanical and digital display units of the clock, can be synchronized using an AC frequency signal from an external power supply. Also, a system and method controls mechanical pointers, such as clock hands, in such a way that the exact positions of the pointers are known to the control electronics so that the pointers and digital displays show the same information.

### CROSS REFERENCE TO RELATED APPLICATIONS

This claims the benefit of provisional application No. 60/594173, filed Mar. 16, 2005, the content of which is incorporated herein by reference.

### BACKGROUND

1. Field

These inventions relate to display devices, for example a time display, and also relates to combined analog and digital display devices, for example where the analog and digital display devices present identical information.

2. Related Art

Presentation or display devices may have modes that are matched, or that operate in unison. For example, some display clocks show both a traditional or analog time display and a digital or numeric display, and it is desirable to have a both present the same information in unison. When the clock hands show 3:15, the digital display should show the same numbers. Likewise, other presentation or display devices may operate best when related modes present information in unison, such as dials, gauges and other displays.

Presentation devices also benefit from natural and simplified movements of components, thereby making the viewing of such devices easier. Some display devices may have discrete or discontinuous movements, which may be distracting to a viewer. Additionally, some display devices may have noticeable delays or interruptions in movements, which also may be distracting.

One type of presentation device is an educational or teaching clock. Such clocks may have mechanical movements with a digital display linked to the clock hands. Additionally, some teaching clocks include a speech function. However, teaching clocks are not designed for operation as real clocks, and mechanical clocks may only provide digital readout's at intervals no smaller than five minutes.

### SUMMARY

A presentation or display device and method can be used to present the same information in different formats or modes substantially simultaneously or in unison. Apparatus and methods can also be provided that present information dynamically with relatively natural and pleasing movements. With educational or teaching clocks, apparatus and methods can be provided that are easy to use, that present information in a natural learning format, and with relatively high accuracy, and also that allow a clock to be used as a working clock. These and other features and benefits can be incorporated into presentation or display devices, as desired, including for educational or teaching clocks.

In one example of a presentation or display device, for example a clock, the display device includes a mechanical display unit and a digital display unit and an input to be operated by a user. In one example, the mechanical unit can be a mechanical time display unit having an hour and a minute hand, and the digital display unit can be a digital clock showing hours and minutes. A controller is configured to control the mechanical display unit as a function of input from the user. In the example of a clock, means may be provided for keeping continuous time, for example over a number of hours or continuously. The clock may have a power supply, a counter or internal clock mechanism such as a crystal for providing accurate time and a display change system for changing the display on the clock, for example every minute. The controller may track the output of the crystal and determine the elapsed time, for example at one minute intervals.

In another example of a presentation or display device, for example a clock, the display device includes mechanical and digital displays and accepts input from a user. A controller controls at least the mechanical display unit through the use of a stepper motor, for example one that is reliable and has a relatively high accuracy and resolution. The stepper motor described herein preferably can move in increments as small as 7.5 degrees. The stepper motor can then be used to advance or reverse the direction of the mechanical display. Additionally, the stepper motor can be used in the case of the clock to change the mechanical display in increments not only of one minute intervals but also other intervals. For example, a mechanical time display can be changed in 5, 10, 15, 30 and 60 minute intervals, and in other desired intervals, in either or both of the forward and backward directions. The intervals by which the mechanical time display can be changed can be selected by the user, and the clock can include multiple input elements such as buttons having pre-assigned time interval changes. In another example, the presentation or display device can include a selector or display control such as a mode switch for identifying or determining to the device can be used to present the desired information. For example, the selector can have a first position for placing the display device in a working mode or continuous mode, and a second position for placing the display device in a demonstration, teaching for user-controlled mode, allowing the user to change the display configuration as desired. Additional positions on the switch can be used to assign additional modes to the device.

In a further example of a presentation or display device, for example a clock, the device includes a display mechanism for controlling the configuration of the display. A user input is coupled to the display mechanism and is selectable by the user for changing the display from one configuration to another. In one example, the user input can be associated with predefined display configurations. In the example of a clock, the clock can include user input coupled to a clock mechanism wherein the user input is selectable for advancing the clock mechanism predefined discrete amounts. In one example, the predefined discrete amounts are greater than one minute increments, and may be 5, 10, 15, 30, 60 or other discrete time intervals, for example. In another example of a clock, a pivoting knob may be used to change the display, and may be configured such as with a controller to change the display at different rates or speeds and in different directions. For instance, the pivoting knob may advance or reverse the progress or positioning of elements on the display, such as clock hands, and the pivoting knob may be used to change the display without having to fully rotate the knob over 360 degrees or more. The user input including multiple input devices can be positioned on a portion of the presentation or display device that is not visible when viewing the display. For example, the user input can be placed on a back side of the display, or at other positions not affecting or impeding viewing of the display. In the example a teaching clock, for example, the user input can be placed on the back of the clock so that viewing of the clock face are not affected.

In an additional example of a presentation or display device, for example a clock, the device uses DC current and includes a coupling element for receiving an alternating current input. A controller in the device uses the alternating current input other than for powering the controller. For example, the alternating current input can be used to synchronize a function of the controller, for example clock output, timer, counting, or the like. In the example of a clock, the clock can include a DC circuit getting direct current from either a battery supply or from an AC/DC converter circuit. The AC/DC converter circuit may get current from an AC/AC converter, which reduces line voltage to a level that can be accepted by the controller, as well as to a level suitable for the AC/DC converter circuit. The AC/DC converter circuit may be a bridge circuit, and the AC circuit input to the controller may be taken off part of the bridge circuit.

In another example of a presentation or display device, for example a clock, the device can be controlled in part by storing a value representing a quantity, for example time, in a controller memory. In one instance, the value can be stored when the quantity reaches a certain magnitude, and in the example of a time value, the value can be stored when the counter reaches an elapsed time such as a minute. When the counter reaches a value representing a desired quantity, a display configuration on the display device is changed. In the example of a clock having both a mechanical or analog display and a digital display, when the counter reaches a value representing a minute, both displays are updated simultaneously or substantially in unison. The two displays appear synchronized or in lock step with each other, and preferably both display the same information, namely the same time. In other display devices, to displays can be controlled so as to appear synchronized or otherwise changing together.

In another example of the operation or control of a presentation or display device, for example clock, a circuit in the presentation or display device can be actuated to change a configuration of the display by a predetermined variation. For example, a configuration of the display can be changed by a predetermined magnitude or quantity, and in the example of clock, the time presented on the display can be changed by a predetermined amount of time, such as other than a minute and other than an hour, and in one example the predetermined amount of time is greater than a minute but less than an hour. The predetermined amount of time could be less than a minute, and could be more than an hour, as well. For example, the display device can include multiple inputs, each input representing a predetermined variation for changing a configuration of the display. In the example of a clock, some of the multiple inputs can represent different times, for example 5, 10, 15 minute or other intervals of change. The display changes can be carried out using a number of elements, one of which may include a stepper motor, which in the context of a clock, can reliably advance the hands of the clock the desired amount and direction. Additionally, multiple input configurations can allow a user to give sequential inputs to the device, each of which will in turn change the configuration of the display. For example, in a teaching clock, the teacher can first advance the clock display by 60 or 30 minute increments to teach hour and half-hour time variations and then advanced the clock display by 15 minute increments to teach quarter hour variations. Other combinations can also be used.

In another example of a clock assembly, a motorized clock hand system rather than a standard clock mechanism is used, and includes a motor and gearing system that allows the hands to be moved bi-directionally and at different speeds, for example to provide lessons to a child. The clock also has a digital LED clock display, which can be turned on or off depending on the teaching mode. This feature allows the child to guess or try to read the time, and then switch the digital display on to see if they were correct. Many other teaching modes are made possible.

In an additional example of a clock assembly, the clock has a stepper motor connected through a gear train to concentric hour and minute hands. The stepper motor is controlled by a microcontroller to enable the clock hands to move forwards and backwards at various speeds and accelerations. The microcontroller is also connected to a digital LED clock display and depending on operating mode, the LEDs can be on, off, and can represent either the time shown on the clock hands, real time, or some other time.

In one configuration, a user interface consists of a rotary multi-position switch, and an optional array of pushbuttons. There also may be a number of other buttons, or switches, to select operating modes. The rotary switch can be used to configure one or more of the displays, for example to move the clock hands or to configure the digital display, depending on mode, clockwise or counterclockwise, and at various speeds. The variation in speed can be determined by an algorithm in the microcontroller that interprets the settings of the multi-position rotary switch and accelerates between different fixed speeds, or by other means. In the example of an algorithm, the algorithm can be configured to provide a natural-feeling presentation or interface for the user. In another configuration, the user interface includes various pushbuttons or switches to select teaching and operating modes, and also to optionally set specific times, jump forward or backward by fixed amounts and/or configure the digital display. A teacher, for example, can turn off the display, set the clock to a certain time, and have the student try to tell what time the hands show. Then the teacher can turn the digital display back on, and the child can see the correct time and see if they were right. The user interface may also be used to move the display(s) to a predetermined position, for example 12:00, 6:00, 8:00 or other times. Predetermined positions may be useful for demonstrating the time to be displayed when an event will occur, for example the start of class or the like. The user interface may also be used through buttons or other input to change the sweep speed of the hands, as well as other configurations of the display.

In another example, any of the display assemblies described can be combined with speech technology to provide audible feedback to the viewer, such as a child. In the examples described herein, speech can be easily implemented because the system knows at all times where the clock hands are. In fact, this capability can be exploited to create a clock that will actually take the teaching role. The clock can, through a microcontroller algorithm, decide to set the hands at, for example, 12:33, and then ask the child through the voice system to input the time on a keypad. Alternatively, the clock can issue an audible command to the child, such as “Please use the control knob to set the time to 11:47.” Then, depending on what the child does, it can prompt them until they get it right.

The capabilities presented by these examples permit many ways of interacting with a viewer or a student. Many of the same features could also be incorporated in a clock for general usage, for those who would prefer to set their times and alarm times using the clock hand display, rather than the digital display — or, for those who would like to have a dual display clock with real mechanical clock hands as well as a digital readout.

One or more examples are set forth more fully below in conjunction with drawings, a brief description of which follows.

### BRIEF DESCRIPTION OF THE DRAWINGS

FIG. 1 is a front elevation view of a presentation or display device in the form of a clock incorporating one or more aspects of the present inventions.

FIG. 2 is a rear elevation view of the clock of FIG. 1.

FIG. 3 is a vertical cross-section through a middle portion of the clock of FIG. 1.

FIG. 4 is a plan view of gears and a stepper motor for use with the clock of FIG. 1.

FIG. 5 is a side elevation view of the gears and stepper motor of FIG. 4.

FIG. 6 is a side elevation view and partial schematic of a user input system for controlling a mechanical portion of the clock of FIG. 1.

FIG. 7 is a front elevation view of the clock of FIG. 1 and a partial schematic of a user input selection to produce the display shown on the clock.

FIG. 8 is a front elevation view of the clock of FIG. 1 and a partial schematic of a user input selection to produce the display shown on the analog and digital portions of the clock.

FIG. 9 is a front elevation view of the clock of FIG. 1 and a partial schematic of a user input selection to produce the display shown on the clock.

FIG. 10 is a front elevation view of the clock of FIG. 1 and a partial schematic of a user input selection to produce the display shown on the clock.

FIG. 11 is a front elevation view of the clock of FIG. 1 and a partial schematic of a user input selection to produce the display shown on the clock.

FIG. 12 is a front elevation view of the clock of FIG. 1 and a partial schematic of a user input selection to produce the display shown clock.

FIG. 13 is a schematic showing input, control and operating portions of the clock of FIG. 1.

FIG. 14 is a block diagram representing components of the clock of FIG. 1.

FIG. 15 is a detailed schematic of the power input for the device of FIG. 1.

FIG. 16 is a detailed schematic of the digital clock circuit for the device of FIG. 1.

FIG. 17 is a detailed schematic of the circuit for controlling the stepper motor end of the optical isolation circuit for use with the clock of FIG. 1.

FIG. 18 is a detailed schematic of the controller and various user input circuits for use with the clock of FIG. 1.

FIG. 19 is a flow chart representing an overview of system operation.

FIG. 20 is a flow chart representing the procedure for calibrated the controller with the clock hands.

FIG. 21 is a flow chart representing the procedure for maintaining a proper time reference for the controller.

FIG. 22 is a flow chart representing the procedure for tracking real-time in the clock.

FIG. 23 is a flow chart of part of the procedure for monitoring and operating according to input from a mode switch.

FIG. 24 is a flow chart of part of the procedure for monitoring and operating according to input from the mode switch.

FIG. 25 is a flow chart of part of the procedure for monitoring and operating according to input from a rotary switch.

FIGS. 26 and 26A are flow charts of part of the procedure for monitoring and operating according to input from the rotary switch.

FIG. 27 is a flow chart representing the procedure for monitoring and operating according to input from time jump buttons.

FIG. 28 is a flow chart representing a procedure for controlling a stepper motor.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of presentation and display devices and of methods of making and using the devices are described. Depending on what feature or features are incorporated in a given structure or a given method, benefits can be achieved in the structure or the method. For example, devices using increment or jump buttons may be easier to use and produce a more natural or pleasing display. They may also provide a more traditional teaching mode.

In some configurations of presentation or display devices, improvements can be achieved also in assembly, and in some configurations, a relatively small number of components can be used to provide a more usable device. For example, a clock with a relatively small number of gears for the mechanical clock hands can produce the desired smooth motion in a relatively small package, especially when using a stepper motor such as that described herein.

These and other benefits will become more apparent with consideration of the description of the examples herein. However, it should be understood that not all of the benefits or features discussed with respect to a particular example must be incorporated into a device, component or method in order to achieve one or more benefits contemplated by these examples. Additionally, it should be understood that features of the examples can be incorporated into a device, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a device and of methods of making and using the devices are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

Clock devices are used as examples of presentation and display devices that can incorporate one or more of the features and derive some of the benefits described herein, and in particular teaching clocks. However, one example of a device will be described with respect to displays, namely a teaching clock. Devices other than clocks can benefit from one or more of the present inventions.

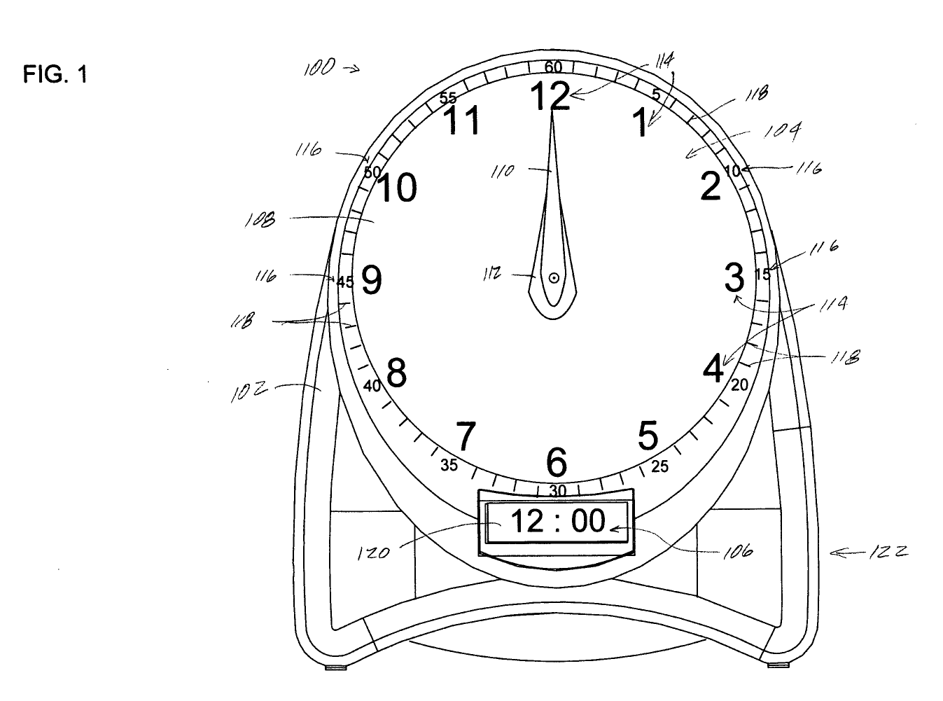

A presentation or display device is shown in the drawings in the form of a clock 100 that can be used as a conventional time keeping device as well as a teaching or learning clock. A clock will be used as an example of a device in which the various components described herein can be used. However, it should be understood that other devices can benefit from one or more of the apparatus or methods described herein. In the example shown in FIGS. 1-3, the clock includes a body 102 supporting and partially enclosing the components for the display is in the form of a mechanical or analog clock 104 and a digital clock 106. The mechanical clock 104 includes a display having a clock face 108 and an hour hand 110 and a minute hand 112 for indicating the time in a conventional format. In the example shown in the drawings, the clock is a learning clock and includes indicia in the form of numbers 114 representing hours. It also includes indicia 116 representing minutes in increments of 5 and intermediate indicia in the form of marks or lines 118 indicating minutes in increments of one minute each. As discussed more fully below, the minute hand is configured to be directed at either the indicia 116 or the indicia 118 upon the completion of every one minute interval, when the clock is in the working or normal time keeping configuration. In the present example, the clock in the working mode has the minute hand sweep in the conventional manner, and in the configuration described, the minute hand advances through an angle or an arc representing a quarter of the distance between each minute indicia (116,118) every quarter minute. Through the combination of ¼ motions, the minute hand 110 will be aligned with a minute indicia at the end of each one minute interval, assuming the minute hand began in alignment with a minute indicia. In one configuration of the teaching clock, and specifically the demonstration mode, pushing an increment button or jump button, for example for a five-minute or 10 minute increment, carries out two processes. First, the controller checks the minute hand location. If the minute hand 110 is on a minute mark, then the controller causes the stepper motor, described more fully below, to advance the minute hand the selected minute increment (five-minute or 10 minute) as the second step. If the minute hand 110 is between minute marks, the controller accounts for the partial progress away from the next preceding minute mark and then moves the minute hand and then in the second step moves the minute hand 110 the selected minute increment from the preceding minute mark. Similar adjustments can be made in the working mode when setting a new time.

The hour hand 112 in the working mode also sweeps the clock face 108 in a manner similar to a conventional mechanical clock. As soon as each one-hour interval is completed, the hour hand 112 will be aligned with one of the hour indicia 114. In the present example, the clock in the working mode has the hour hand advance through an angle or an arc representing 1/240 of the distance between each hour indicia 114 with each movement of the minute hand. Through the combination of motions, the hour hand 112 will be aligned with an hour indicia 114 at the end of each one-hour interval, assuming the hour hand began in alignment with an hour indicia. In another configuration, for example where the starting time is 1:15 and the hour hand is ¼ the way between “1” and “2”, the hour hand will be ¼ the way between “2” and “3” after an exactly one-hour interval, for example after pushing a 60 minute jump button (described more fully below).

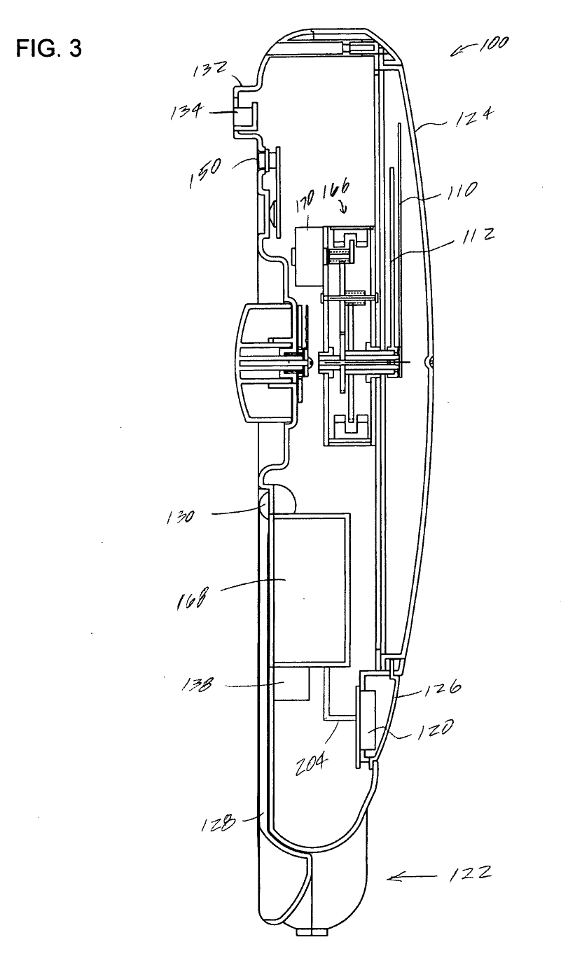

The digital clock 106 includes an LED display 120 incorporating four seven-segment LED components, one for each digit, as well as two LED's for the colon. In the example shown in FIGS. 1 and 3, the digital clock is below the mechanical clock in a base 122 of the clock. The digital clock can be illuminated or un-illuminated, as a function of user input. For example, as a teaching clock, the digital clock can be turned off when students are being tested on clock reading skills, or can be turned off over long periods of time until students more confidently master their clock reading skills.

The mechanical clock is protected by a cover 124 (FIG. 3) formed of clear plastic or other see-through material. The digital clock is also protected by its own cover 126 also formed of clear plastic or other see-through material. The clock may also include a movable stand 128 pivoting around a minute. 130 in the back of the clock, allowing the stand to create an A-frame configuration to support the clock on a desk or other surface. A boss or other structure 132 includes an opening 134 for receiving the end of a hook, fastener or other support for hanging the clock on a wall or similar surface.

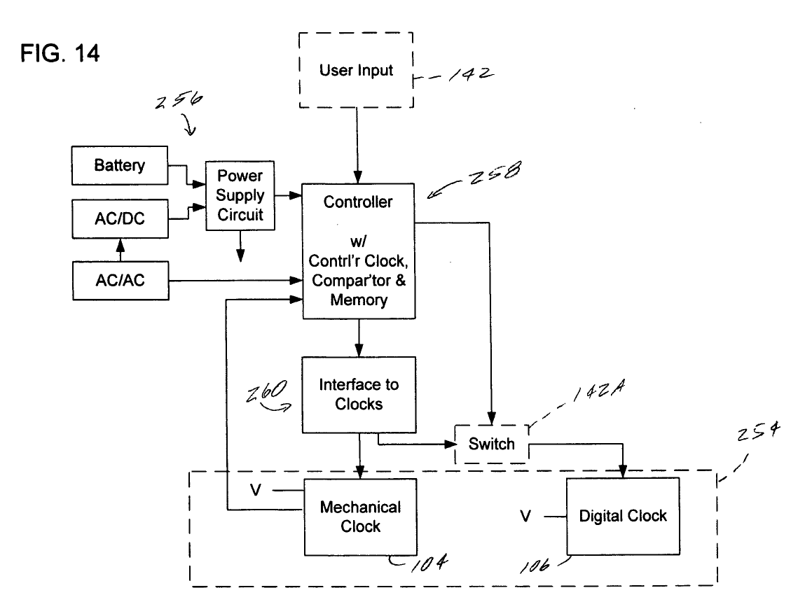

The back of the clock also includes a battery compartment 136 for receiving and holding for C-size batteries. The battery compartment 136 also includes connectors for the batteries (not shown) so that direct-current can be supplied to the clock. The clock also includes a reset button 138 and a receptacle 140 on the back clock. The reset button 138 resets the clock mechanism, including moving the hour and minute hands to 12, and resetting counters in the controller so the values in the counters correspond to the hour and minute hand positions at 12 O' clock. The receptacle 140 on the back of the clock is a junction for receiving input from an AC power supply, which is preferably a low voltage input from an AC/AC down converter or transformer connected to a line power supply. The receptacle receives and allows the AC/AC transformer to supply a synchronization signal for the controller, as well as power for the clocks. The input may be any conventional frequency such as 50 Hz or 60 Hz, and preferably about 6.0 volts at 500 mA. The AC/AC down converter preferably accepts line input at either 220 or 230 volts or 110 volts (or both if designed to accept both) and converts it to 6.0 volts at 500 mA. The AC/AC transformer is referenced below at 228 in conjunction with the discussion of FIG. 13.

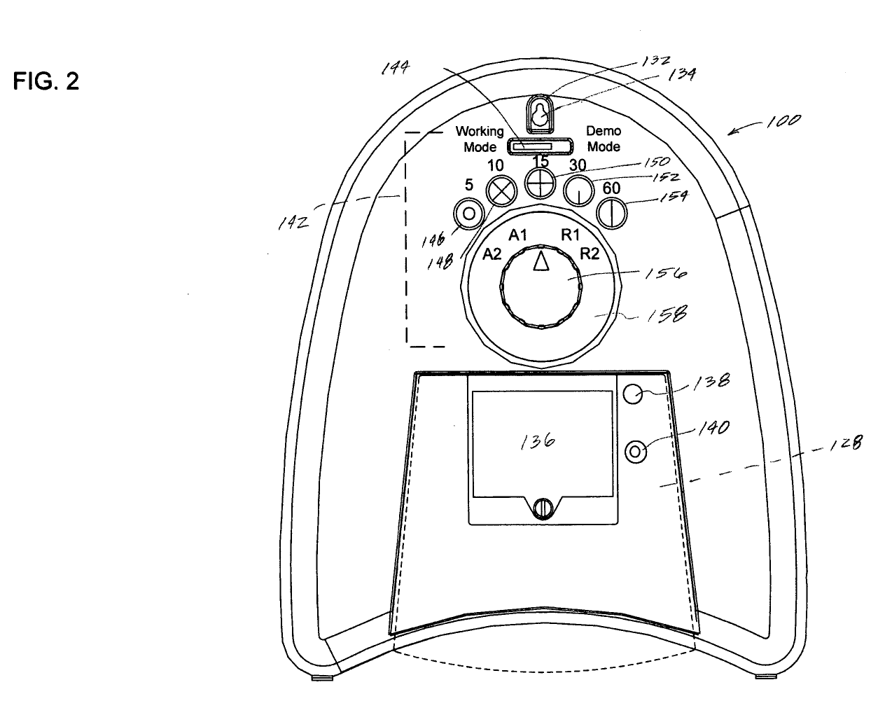

One or more input elements 142 (FIG. 2) are included on the clock 100. The input elements can be used by the user to select how the clock operates. In some cases, it is desirable to allow the user to determine how one or more of the displays present information. In the example of a clock, the user may want to have the flexibility of turning off one or more of the displays, the user may want to advance or reverse the clock by predetermined increments and/or the user may want to advance or reverse the clock continuously. Other combinations of control features may also be desirable. For example, there may be a manual demonstration mode or an automated speech generating mode, such as may be used to instruct or test students. Several of these forms of user input will be described more fully below. In the example shown in FIGS. 2 and 3, the user inputs are on the back of the clock while still being easily accessible by the user, but allowing free and un-obstructed viewing of the displays on the front of the clock. The input elements can take a number of configurations, several of which will be described with respect to the example shown in the drawings.

In the present example, the clock 100 includes a user input element in the form of a two-position mode switch 144 (FIGS. 2 and 6-12) on the back of the clock. The mode switch 144 allows the user to select a working mode or a demonstration mode, such as is depicted in FIG. 2. In the working mode, the clock 100 operates as a normal working clock showing the correct time on either or both of the analog and digital displays. Once the clock is calibrated and the correct time set, as discussed more fully below, the clock can be displayed and used as any other clock would be. The clock hands would sweep and display the correct time, and if the digital clock is turned on the digital clock will show the correct time. Additionally, in the present example, the digital clock shows the same time as the analog clock, with the digital clock incrementing to the next minute as soon as the minute hand 110 reaches the next succeeding minute as the minute hand sweeps.

In the demonstration mode, also called the demo mode, the mode switch 144 is to the right of the position of that switch shown in FIG. 2. In the demo mode, control over changing the display for the analog clock and for the digital clock is removed from the controller (discussed more fully below) and turned over to the user. In the demo mode, user input elements 146,148,150,152 and 154 are activated by the controller so that they can be used by the user to control the display. In the working mode, the user input elements 146-154 are inactive, but they could be configured to be active as well.

The user input elements 146-154 are push buttons in a circuit coupled to the controller. The user input elements may be other types of electro-mechanical devices such as pivoting knobs, switches, slides or other devices that can be used to change one or more displays. In the present example, the push buttons are PCB dome type push buttons. The push buttons are arranged over an arc on the back of the clock, for example to at least partly approximate a user's fingertips positions. Each of the push buttons 146-154 have different surface configurations. In the example shown in th the push button 146 has a circular bump protruding from the outer surface of the push button, the push button 148 has an X raised from the surface of the push button, push button 150 has a cross, push button 152 has a downwardly depending the bar extending from the center to the bottom of the button and push button 154 has a vertical line extending from the top of the button to the bottom of the button. These protrusions or raised portions provide a tactile sense to user for identifying the buttons without having to look at the buttons.

The push buttons 146-154 are configured with the controller to advance the clock by predetermined increments. When the clock is in the demo mode, the clock displays do not change until one of the user input elements is actuated. In the present example, push button 146 is configured to advance the clock display by a five-minute increment. Therefore, pushing the push button 146 advances the then-present display by five-minutes. The push buttons could also be used to reverse the display, but conventional teaching modes typically do not teach the clock hands moving in reverse. As configured in the example, the clock advances a single five-minute increment with each pressing of the push button 146, but holding down the push button 146 does not produce additional movement beyond the first increment. However, the push buttons can be configured otherwise. Additionally, the push button 146, as well as the other push buttons, can be configured to change the clock display in ways other than the increments for which they are configured in the present example, including but not limited to increments not divisible by 5, both advancing and going backward or only one of those directions, operating in all or less than all clock or display modes, and the like. For example, in time setting of the working mode, it might be convenient for the user to be able to jump the time forward or backward by the indicated increments.

The push button 148 is configured with the controller to advance the clock by a 10 minute increment, and the push button 150 is configured with the controller to advance the clock by a 15 minute increment. The push button 152 is configured with the controller to advance the clock by a 30 minute increment, and the push button 154 is configured to advance the clock by a 60 minute increment. The controller is configured for each push button to advance the clock display by the identified increment from the then-existing clock display. Therefore, for example, if the clock were starting at 12:00, the display would appear as in FIG. 1 with the minute hand 110 and the hour hand 112 pointing straight up, and the digital display 106 showing 12:00, if the digital display were actuated. Thereafter, pressing the five-minute push button 146 advances the display to 12:05, with the displays advancing a five-minute increment from the then-existing 12:00 display. If the 15 minute push button 150 were then pressed, the display would advance from the then-existing 12:05 to 12:20. Pressing the 10 minute push button 148 would then advance the clock display from the then-existing 12:20 to 12:30, after which pressing the 30 minute push button 152 would change the display to show 1:00. These incremental movements could be applied in any order and in any combination, which allows the user to demonstrate or teach time-telling skills with the clock 100 using conventional teaching modes. As noted above, other user input elements can be used to allow the user to change the displays, and the exemplary or other user input elements can be configured in other ways allowing the user to change the displays.

A user input element in the form of a knob 156 is also located on the back of clock 100. The knob 156 is centered widthwise of the clock in a circular depression 158 in the back of the clock, allowing the user easy access to knurled or grooved outside surfaces of the knob. The knob 156 includes a top center position where the knob is not active, and first second positions to each side of center where the knob is active. In the positions represented by A1 and R1, the knob 156 changes the display continuously at a first speed group. In the positions represented by A2 and R2, the knob 156 changes the display continuously at a high speed group generally faster than the first speed group. The positions represented by A1 and R1 change the displays relatively slowly so that the displays changed minute to minute continuously until the desired clock position is produced. In the present example, the knob positions A1 and R1 change the displays after a one second pause relatively slowly minute by minute at a first slow speed, and if the knob remains at the positions either A1 or R1, the rate of change of the displays increases to an intermediate level or levels, and if the knob position is not put back to center, the rate of change of the displays increases to a final faster level (for the A1 or R1 positions) where it remains until the knob is repositioned. The knob position A1 advances the mechanical clock clockwise and advances the time display on the digital display if the digital display is active. The time display on the digital display substantially matches the time display on the mechanical clock, even while the mechanical time display is changing. The knob position R1 reverses the mechanical clock counterclockwise and moves the digital time display backward. The knob may be part of a 5 position rotary switch, a potentiometer, a capacitive switch assembly or other suitable assembly for moving the display elements, in this example the hands of the mechanical clock.

It should be noted that in the view of the backplane of clock, advancing the clock display is carried out by turning the knob 156 counterclockwise. This configuration of the knob 156 motion is a natural configuration when the user is holding the clock and looking at the clock face with one hand on the knob 156. To advance the clock display while viewing the display, the natural tendency is to pivot the knob 156 in the direction of movement of the clock hands as viewed from the front, which is counterclockwise for the knob 156 when viewed from the back. Similar comments apply for turning the knob 156 when the user wants to move the hands counterclockwise.

The knob 156 positions represented by A2 and R2 change the displays at high-speed so that the displays can be changed over multiple minutes or hours continuously until the desired clock position is produced, possibly in conjunction with the positions A1 or R1 as the clock hands approach the desired time. The knob position A2 advances the clock hands and digital display, while the knob 156 position represented by R2 reverses the clock hands and digital display. When the knob 156 is in either of the positions A2 or R2, the displays are changed after a one second delay minute by minute at a first high-speed, and if the knob 156 remains in position, the displays are changed at one or more intermediate higher-speed and then at a final high-speed, higher than the previous speeds, which is maintained until the knob 156 is moved. These motions of progressively higher speeds of display change (of both low and high speed groups) provide for more natural-appearing display changes, that are relatively smooth and are less distracting than discrete or broken movements.

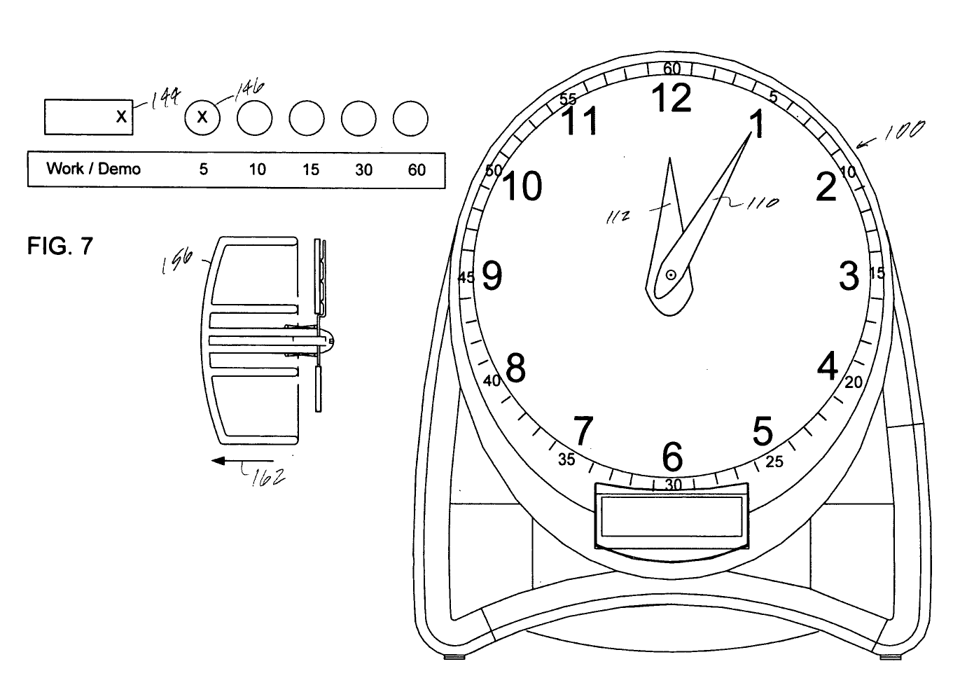

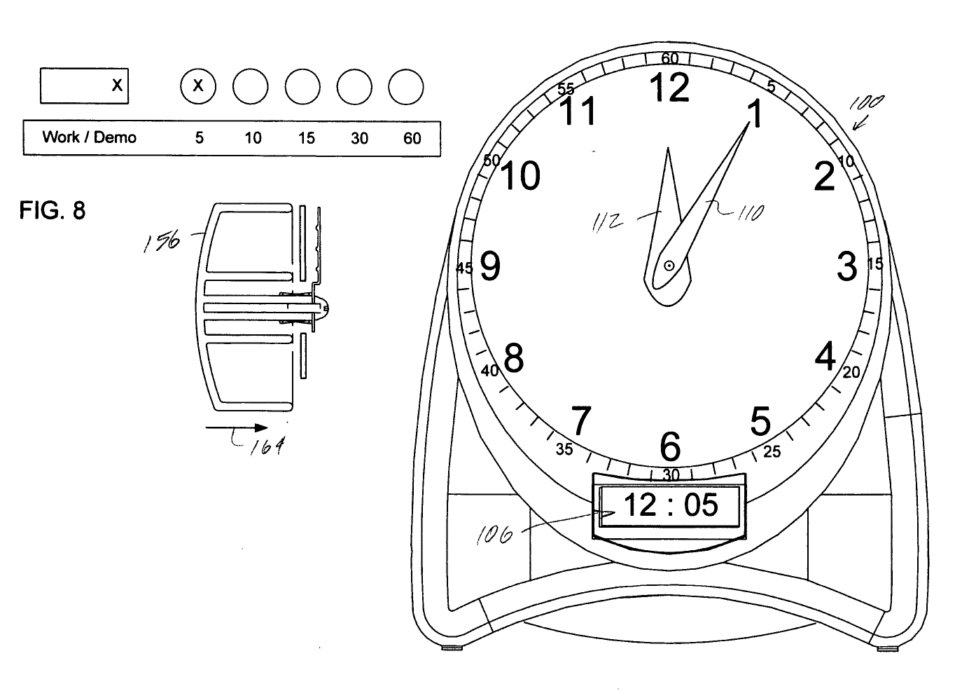

The knob 156 is also axially movable as represented by the arrow 160 in the schematic of FIG. 6 between a first axial position as represented in FIG. 6 and a second axial position as represented in FIG. 7. In the first axial position, the digital display 106 is active. In the second axial position, the digital display is inactive or turned off. The axial movement of the knob 156 can be used for other functions, but using the knob to turn the digital display on and off is a convenient and accessible way to change the digital display during a teaching or testing mode. Therefore, for example, in the demo mode, the user can advance the clock hands while leaving the digital display off and have the student tell the time. The user can then turn on the digital display by pushing in the knob 156 to the first axial position to show the student the digital form of the time. Additionally, a teacher can leave the digital display off during regular class hours until the students become more proficient at properly telling time from the clock hand positions. The axial movement of the knob 156 turns off and on the digital display regardless of the position of the mode switch 144. Other means may also be used to turn the digital display on and off, including a switch on the clock front adjacent the digital display.

Considering a brief example of clock operation, starting with initial power up, the present example does not include but could have an on/off switch. The system is powered up by adding batteries or by connecting the AC/AC converter. The clock synchronizes by having the displays move a relatively small amount to determine whether the displays are close to 12:00. In one example, the minute hand is moved back about 4 minutes, and the system senses whether the hour hand position indicator reveals (through its optical sensor) that the hour hand is on the “12”. If the hour hand is on the “12”, the clock is set to 12:00 by moving the hands and the LEDs backward to 12:00. Between approximately 12:05 and 11:59, the clock hands are moved forward to synchronize at 12:00. When the clock hands both reach 12:00, the clock hands stop and the controller moves the minute hand backward about 5 minutes and then moves it forward until the minute hand points precisely to “12”. This check ensures first that the hour hand is on “12”, and after moving the minute hand backward and forward over about a five-minute arc once the hour hand position is known, then the minute hand location is known. (When the clock is first assembled, position indicators are included and positioned at the desired locations, such as in front of optical sensors, and then the hour and minute hands are mounted to their respective shafts. Thereafter, when the position indicators are aligned in front of the optical sensors, the hands will be pointing to 12:00. It should be noted that any time can be chosen as the reset or synchronization time, but 12:00 is convenient not only mechanically for aligning the hands and for the user recognizing 12:00 as a starting point but many clocks start at 12:00.) This process occurs regardless of the mode switch position. Thereafter, the controller keeps track of the time. If the mode switch 144 is in working mode and the knob 156 is moved to change the time (either forward or backward), the controller keeps track of the clock hand movements in a counter and waits for the user to finish moving the clock hands. After a suitable delay, the controller takes the then-existing clock hand position (as moved by the user) and the then-existing counter value as the correct time, until the user changes the time again using the knob 156 when the mode switch 144 is in the working mode. With the desired time showing in the working mode, the clock can be used as a normal working clock. The digital display can be turned on or off using the axial positioning of the knob 156. Pushing the reset button 138 causes the clock to go through the same process as occurred during power up regardless of the mode the clock is in.

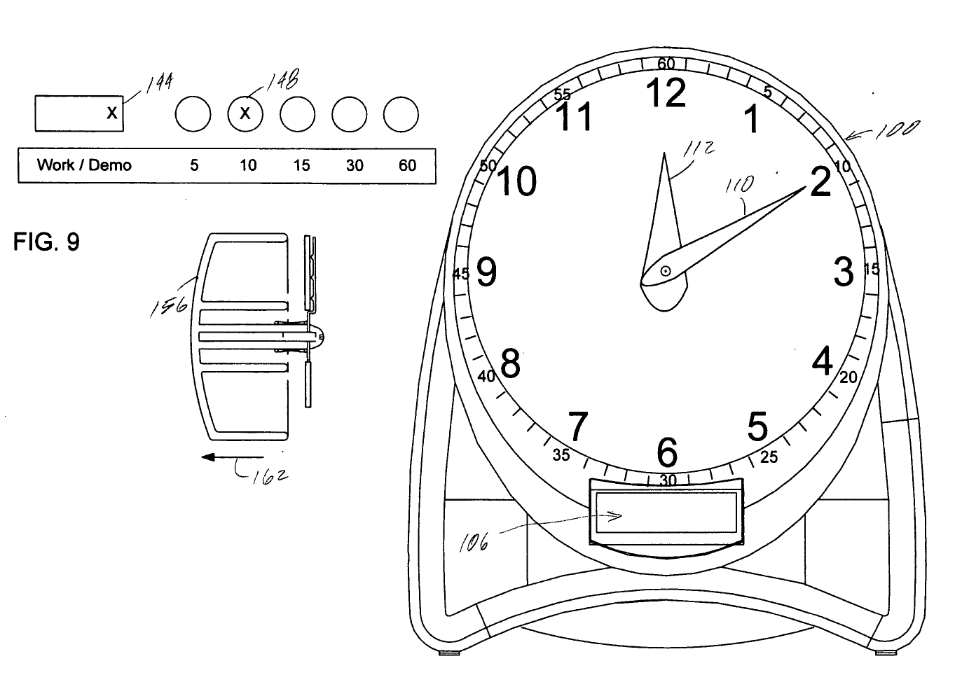

If the user changes the mode switch 144 to demo mode, and the then-existing display shows 12:00, the clock would appear as shown in FIG. 1. If the then-existing display shows another time, that time would remain even though real time progresses, but the controller keeps track of the elapsed time from when the mode switch is moved to demo mode to the time when it is switched back to working mode. In the example where the then-existing time is 12:00, if the user wanted to demonstrate a clock setting of or time progression to 12:05, with the digital display off, the user would pull the knob 156 out as represented by the arrow 162 (FIG. 7). The user could then use the knob 156 to advance the minute hand 110 to point to the “1”. However, an easier way is to push the five-minute increment push button 146 when the mode switch 144 is in the demo mode. This configuration is shown in FIG. 7, with the X in the mode switch 144 representing the “demo mode” and the X in the five-minute increment push button 146 representing actuation of the five-minute increment button. The user may then show the digital form of the display or ask a student what time the clock hands show, after which the correct time is shown on the digital form of the display 106. The user turns on the digital clock 106 by pushing in the knob 156 as represented by the arrow 164 in FIG. 8. The clock 100 shows the minute hand 110 pointing to the “1” and the hour hand 112 pointing to be “12”. The digital clock displays 12:05.

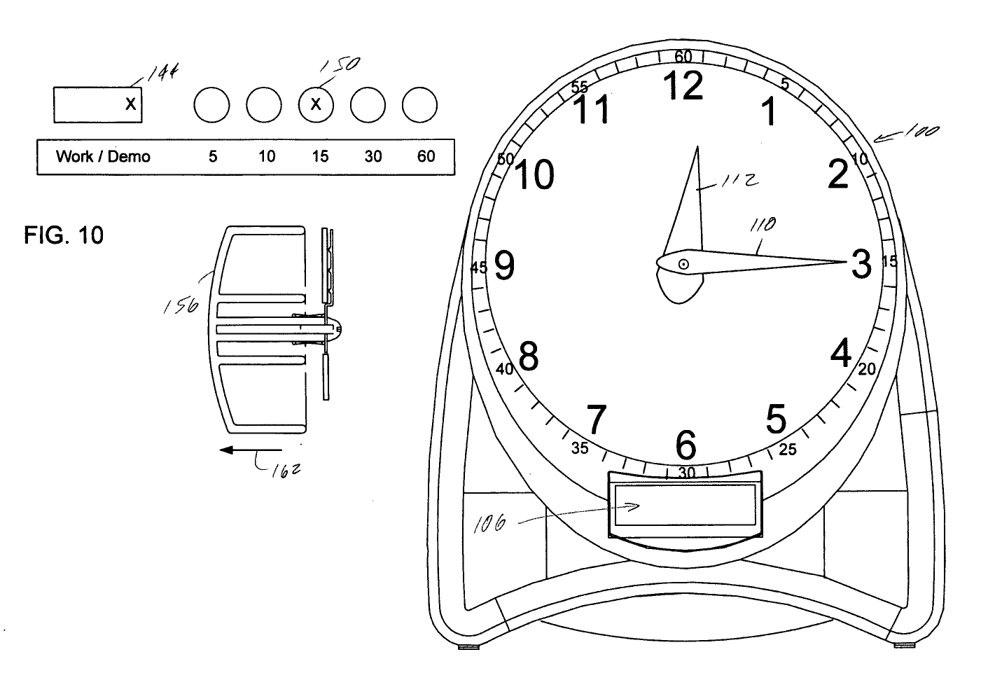

In another example, if the user wanted to advance the clo minute increment, from 12:00, while in the demo mode, the user could push the 10 minute increment push button 148. Actuation of the 10 minute push button 148 is designated in FIG. 9 by the “X”. The minute hand 110 then advances in a smooth motion from “12” to “2” to the display shown in FIG. 9. The analog clock displays a time of 12:10. The user can have the digital clock 106 display off by having the knob 156 pulled out.

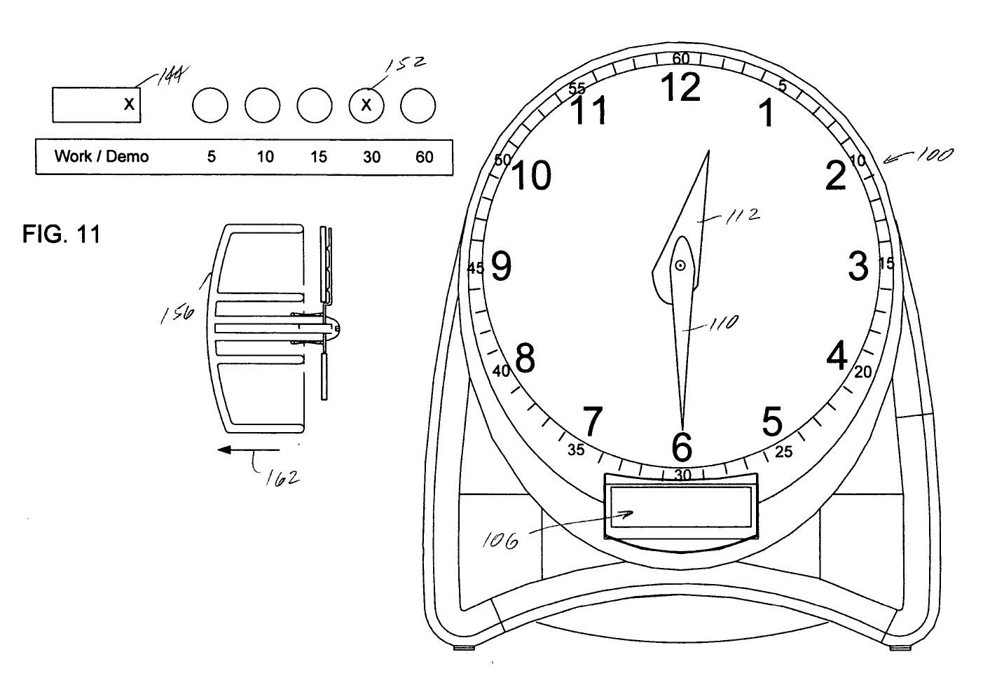

In an example of a 15 minute increment, in the demo mode, the demo mode switch is positioned as represented in FIG. 10 by the X, and the user pushes the 15 minute increment button 150. Actuation of the 15 minute push button 150 is represented by the X. The minute hand 110 then advances in a smooth motion from “12” to “3” to the display shown in FIG. 10, and a small movement of the hour hand 112 is also shown. The clock hands then show a time of 12:15. The user can have the digital clock 106 display off by having the knob 156 pulled out.

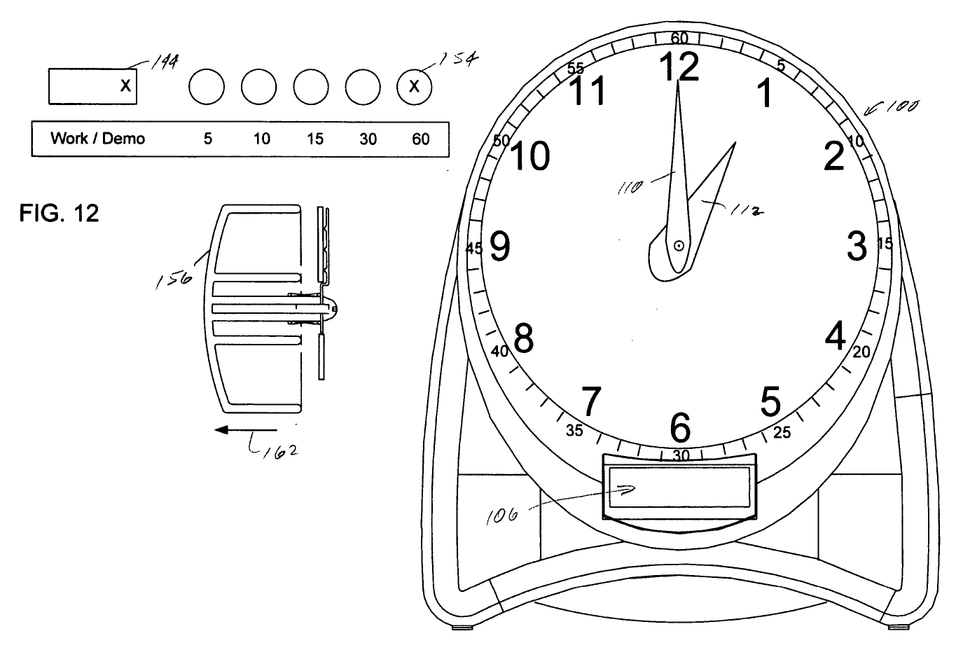

An example of a 30 minute increment in the demo mode is shown in FIG. 11, where the demo mode in the mode switch 144 is represented by the “X”. Actuation of the 30 minute increment button 152, represented by the “X” in the push button 152 moves the minute hand 110 from the “12” to the “6” in the forward direction, and the hour hand 112 also moves forward approximately ½ the distance between the “12” and the “1”. The clock hands then show a time of 12:30. The digital clock 106 is off.

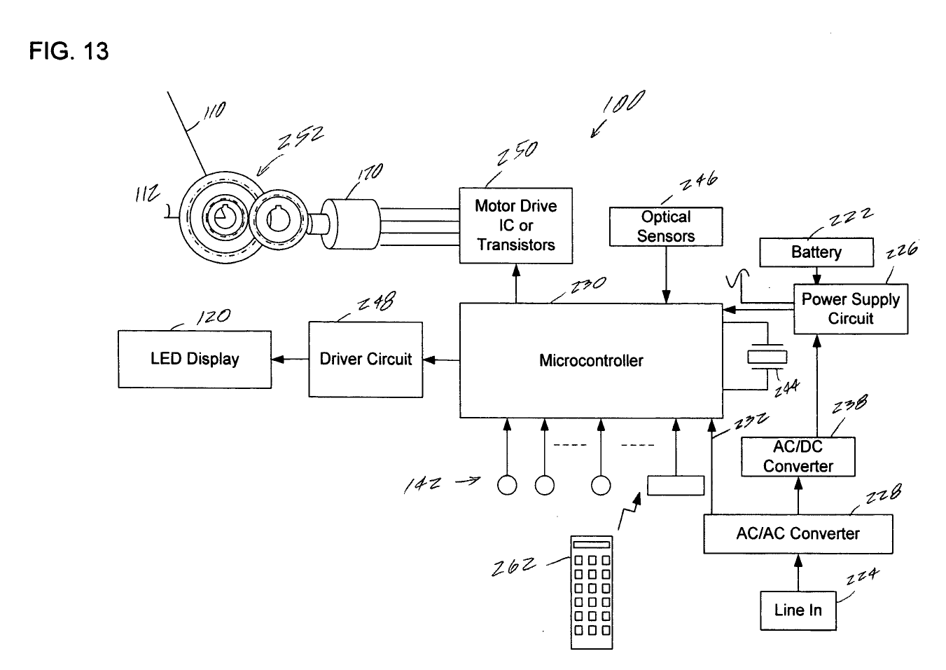

A 60 minute increment in the demo mode is shown in FIG. 12 where the “X” in the mode switch 144 indicates the demo mode and the “X” in the push button 154 indicates actuation of the 60 minute increment button 154. The clock 100 sweeps the minute hand 110 a full circle around the face of the clock from “12” to “12” and the hour hand 112 moves from “12” to “1”. The clock then reads 1:00.

Other clock displays can be presented by actuating the push buttons in combinations or repeatedly. After each actuation, the clock displays a new time, which becomes a new then-existing time. Subsequent activation of another push button then changes the clock display by the selected increment. The user can turn on or off the digital display at any time. All the while, the controller is keeping track of the actual passage of time, and when the mode switch is changed from demo mode to working mode, the clock display(s) are changed to show or display the time as represented by the value in the counter of the controller. Depending on the magnitude of the difference between the time represented by the value in the counter of the controller and the then-existing display, the clock displays will move either forward or backward to display the current time in the working mode requiring the fewest revolutions of the clock hands. Therefore, if the difference in reverse is less than the equivalent of six hours (or the difference forward is greater than the equivalent of six hours), the hands are moved clockwise. If the difference in reverse is greater than the equivalent of six hours (or the difference forward is less than the equivalent of six hours), the hands are moved counterclockwise.

In the present examples, the presentation or display device is an electromechanical device. The clock hands are mechanical in the user inputs are electromechanical combinations and the controller is an electronic device. Considering the electromechanical components in more detail, the clock includes a gearbox and motor housing 166 (FIGS. 3-6) and a circuit housing 168 (FIG. 3) with the various components electronically coupled together as necessary. The circuit housing 168 includes a controller functionally between the input element and the mechanical clock, and the controller is configured to control the mechanical clock has a function of input from the user input elements. Those inputs may be provided through one or more of the mode switch 144, the push buttons 146-154 and the knob 156. The controller also controls the mechanical clock based on actuation of the reset button and removal or application of power. The power supply, the controller and the gearbox 166 components provide means for keeping time continuously so that the clock can operate as a normal time keeping device. The controller and other electrical components will be discussed in more detail below.

Considering the motor and the mechanical components and more detail, the gearbox and motor housing 166 supports a motor 170 (FIGS. 3-6 and 13). The motor 170 changes the mechanical based on input from the controller. The motor 170 is preferably a permanent magnet unipolar stepper motor of 25 mm diameter coupled to four drive transistors, as described more fully below. The stepper motor includes an output drive shaft 172 to which is securely and reliably mounted an input spur gear 174, such as by press fitting or through a mechanical engagement. The stepper motor through the spur gear 174 drives the gear train which turns the mechanical clock hands. A position indicator that may be considered a minute hand position indicator or pointer 176 is also fixed and reliably positioned on the output shaft of the stepper motor 170 or to the gear 174. The position indicator 176 is a bar, pin, rod or other opaque or light-blocking element which interrupts the beam or other test element of a photo sensor 178 or other sensor. The position indicator 176 interrupts the beam once per revolution of the stepper motor output shaft, and can be used as an indication of the position of the minute hand 110. The photo sensor 178 is part of a photo-interrupt module mounted or otherwise supported in the gearbox. The stepper motor 170 may be supported on the outside of the gearbox with the output shaft extending through an opening in a wall of the gearbox. The stepper motor may include a mounting plate 180 that may be used to adjust the angular position of the stepper motor relative to its center axis.

The stepper motor input gear 174 engages and drives an intermediate drive gear 182 suitably mounted for rotation on an intermediate shaft 184 in the gearbox walls. The intermediate drive gear 182 securely engages and drives a minute hand drive gear 186. The minute and right gear is secured or otherwise fixed to a minute hand shaft 188, to which the minute hand 110 is fixed. The minute hand shaft 188 freely rotates within an inner support element 190 (FIG. 6) and also freely rotates within an hour hand shaft 192. As shown in FIG. 6, the minute hand 110 and the hour hand 112 are spaced apart so that they do not contact each other, and freely rotate relative to each other. Their respective shafts are concentric with respect to each other.

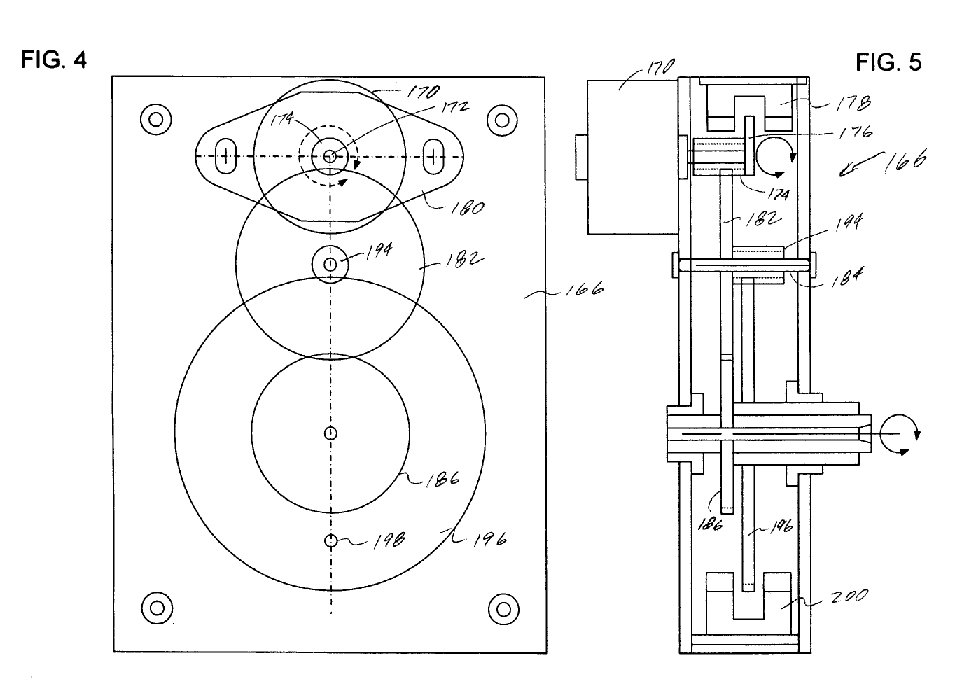

An intermediate drive gear 194 is fixed to the intermediate gear 182 and is also mounted for rotation about the shaft 184. As the intermediate gear 192 rotates, the intermediate drive gear 194 will also rotate to the same extent. The intermediate drive gear 194 reliably engages an hour hand drive gear 196 and drives the hour hand drive gear 186 when the intermediate gear 192 pivots. The hour hand drive gear 196 is fixed and mounted to the hour hand shaft 192 so that as the hour hand drive gear 196 moves, the hour hand drive shaft 192 moves to the same extent. The hour hand drive gear 196 includes an opening 198 (FIG. 4) for passing a light beam or other sensing element from optical sensor 200. The opening 188 may be a circular opening through the hour hand drive gear or may be a radially extending slot or other opening. Alternatively, if the hour hand drive gear is transparent, the position indicator may be an opaque or light-blocking element on the hour hand drive gear. Other position indicators can also be used. In any case, once the clock is properly assembled and the position indicators are aligned with the optical sensors at the same time that the clock and point to 12:00, the controller should determine that the clock ends are in the proper position based on the output of the optical sensors 178 and 200.

The sizes and gear ratios of these five gears are set forth in Table 1 below. As will be understood from the Table, a 6:1 speed reduction occurs between the stepper motor input gear 174 and the intermediate gear 182, and there is a 6:5 step up from the intermediate gear 182 to the minute hand drive gear 186. Additionally, there is a 10:1 speed reduction from the intermediate drive gear 194 to the hour hand drive gear 196. The gears may be made from any suitable material, and the high wear gears can be made from brass or other suitable wear resistant material. Other wear resistant materials, including selected plastics, can be used. The motor, intermediate and minute hand shafts in the exemplary configuration may be 2 mm in diameter.

TABLE 1
Gear specification. All gears are metric, 0.5 module (pitch.)

| | | Pitch Diameter, | Outside Diameter, |
|---|---|---|---|
| GEAR | # Teeth | mm | mm |
| Motor input shaft | 10 | 5 | 6 |
| gear 174 | | | |
| Intermediate gear | 60 | 30 | 31 |
| 182 | | | |
| Minute Hand | 50 | 25 | 26 |
| drive gear 186 | | | |
| Intermediate drive | 10 | 5 | 6 |
| gear 194 | | | |
| Hour hand drive | 100 | 50 | 51 |
| gear 196 | | | |

TABLE 2
Possible shaft spacing

| | Spacing, millimeters, |
|---|---|
| Shaft | center to center |
| Motor to Intermediate Drive Shaft = | 17.5 |
| gears 174 −> 182 | |
| Intermediate Drive Shaft to Minute | 27.5 |
| Hand Shaft = gears 182 −> 186 | |
| Intermediate Drive Shaft to Hour | 27.5 |
| Hand Shaft | (concentric with |
| | Minute Hand Shaft) |

Considering the electronic interfaces between the mechanical components and a controller shown generically at 202 (FIG. 6) and between the controller 202 and the digital display (FIG. 3), the digital display is controlled over suitable conductors 204. As shown in FIG. 6,the push buttons and mode switch portions of the user input elements 142 are coupled to the controller over appropriate conductors such as bus 206. The knob 156 portion of the user input elements 142 may include a printed circuit board 208 helping to support the knob 156 and including appropriate contacts for sensing the pivot position of the knob, for example top center, A1, A2, R1 and R2. The print circuit board 208 is coupled to the controller 202 over appropriate conductors 209. A contact plate 210 is fixed and mounted to a shaft 212 of the knob 156 and pivots and moves axially with the knob. The contact plate 210 causes input to the controller 202 for turning off the digital display.

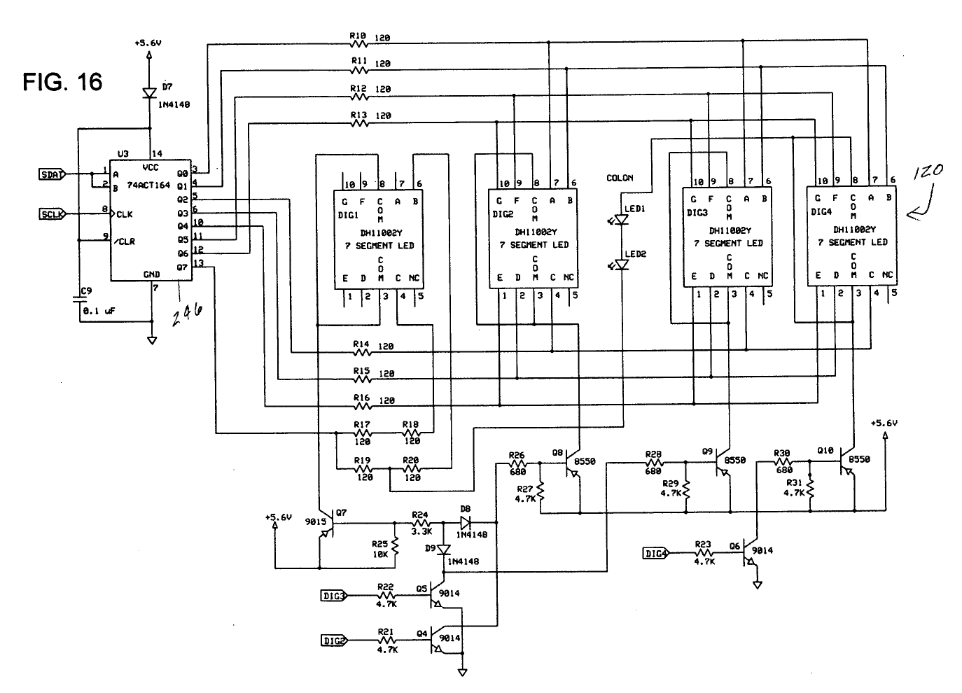

The stepper motor 170 is driven by the controller 202 over appropriate conductors represented at 214. The optical sensors 178 and 200 are monitored by the controller 202 over appropriate conductors 216 and 220, respectively. These and other electrical connections can be seen with a more detailed consideration of the detailed schematics in FIGS. 15-18.

Considering a schematic depiction of a presentation or display device in the form of the clock 100 in conjunction with FIG. 13, the clock is powered either by a battery supply 222 or line current through an appropriate plug and receptacle represented at 224. The battery supply provides DC current to a linear LDO voltage regulator and switching regulator, shown in FIG. 13 as a combination Vin 226. Line current is applied through an AC/AC converter 228 coupled to the input 140 (FIG. 2). The AC/AC converter 228 provides to the clock an AC signal at 6.0 volts and 500 mA, which can be used to provide a low voltage alternating current to a microcontroller 230, which forms part of the generic controller 202 (FIG. 6). The AC/AC converter can be any suitable converter rated for 120 volts AC input and 6.0 volts AC out at 500 mAmp. The low voltage alternating current is applied to the AC detect input 232 of the microcontroller 230 after being passed through a transformer 234 (FIG. 15) and part of a half wave rectifier network 236. The low voltage rectified AC is passed through an RC filter circuit including R9 and C14 in FIG. 15 to filter spikes that may occur on the line input. The network 236 serves as an AC/DC converter 238 (FIG. 13), and is coupled to the power supply circuit 226. The output of the power supply circuit provides a reliable source of 5 current at the desired voltage to properly drive the stepper motor 170 and to properly illuminate the digital display. The power supply circuit 226 is formed in part by the voltage regulator 240, which has a low power draw, and the switching regulator 242 shown in FIG. 15. The switching regulator 242 is on or off based on the HVON setting from the microcontroller, for conserving to power, and is set on for calibration, when the LEDs are on, and every 15seconds when the motor could be powered for movement. The switching regulator 242 is configured in a SEPIC configuration to give 5.6 volts output regardless of the input voltage level. The power supply circuit is coupled to the microcontroller 230, the digital display, the stepper motor and any other components as required.

The input 140, or another input, can also be configured in the system to allow ISP, or In System Programming, taking advantage of Flash Program Memory. The circuit may include a connector J2. The jack J2 allows ISP or In System Programming of the program memory of the microcontroller. This 20 feature of the chip may be enabled by bringing the appropriate signals out to the connector J2. Features can be added to and removed from existing products through the use of this connector. The ISP capability also allows adding features or changing features later. For example, the LEDs time-out time could be changed, such as through the ISP connector. In another 25 example, one button could be dedicated to a special function such as “Move hands to 3:33” and the ISP capability could be used to add that functionality.

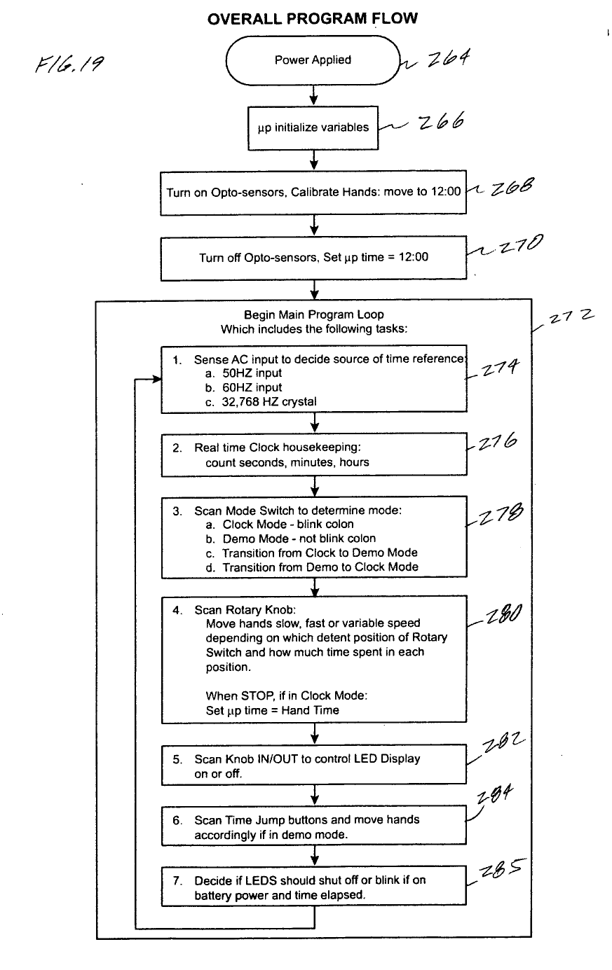

The user input elements 142 also provide input to the microcontroller 230 through their respective electromechanical assemblies. As noted above, the knob 156 includes its printed circuit board that is coupled to the controller. 30 As shown in FIG. 18, the user inputs are electrically coupled directly to appropriate inputs of the microcontroller 230.

A 32,768 Hz watch crystal 244 provides timing for the microcontroller 230 when the clock is running off the battery. When line current is connected to the clock, the microcontroller 230 takes the timing signal from the alternating current from the line in, after checking against the clock crystal as a reference to see if the incoming frequency is 60 Hz or 50 Hz. If the line in is 60 Hz, the microcontroller 230 counts 60 cycles for every second, and if the line in is 50 Hz, the microcontroller 230 counts 50 cycles for every second.

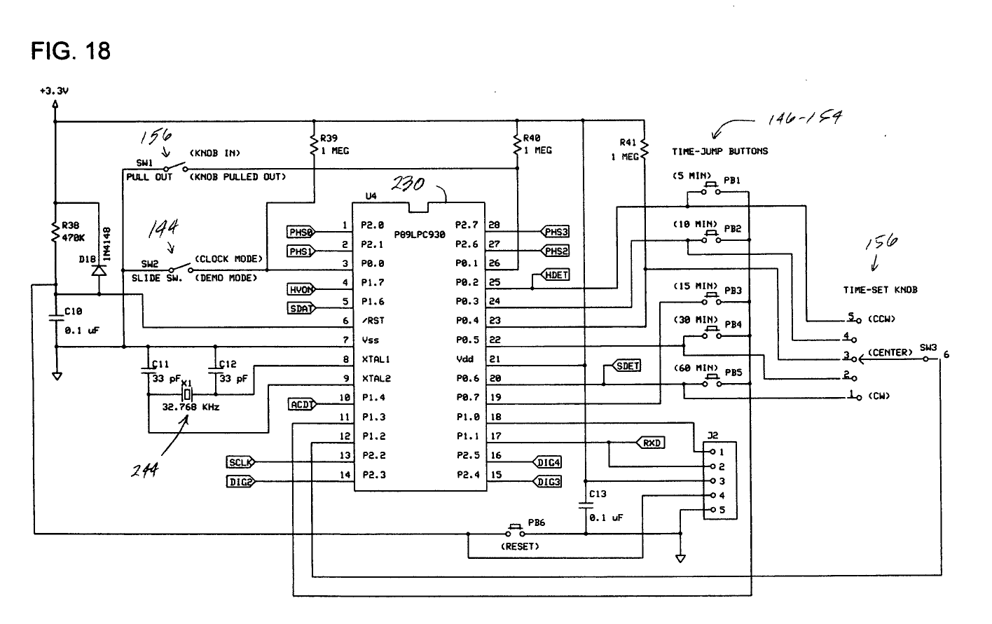

The optical sensors shown in FIG. 13 generically as sensors 246 also provide input to the microcontroller. The optical sensors 178 and 200 are shown in FIG. 17 and provide detection input to the microcontroller.

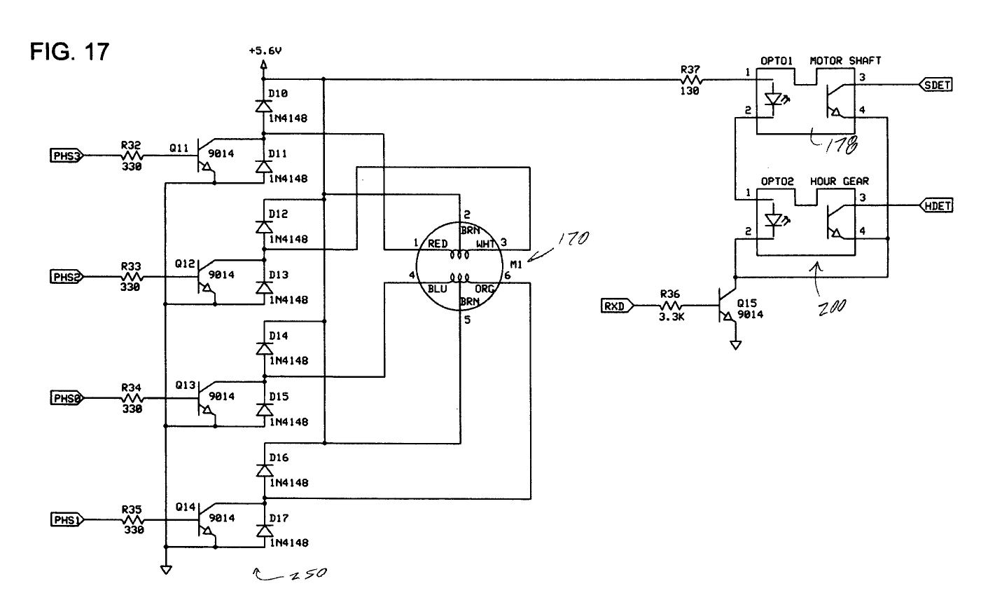

The microcontroller 230 is a Philips P89LPC930 controller, the characteristics and features of which are publicly available and incorporated herein by reference. The microcontroller provides a serial data output to a driver circuit 248 in the form of a shift register (FIG. 16) for providing parallel output signals to the seven segment LED's. The LED's are represented in FIG. 13 by the LED display 120. The multiplexed 3½-digit LED clock display could be substituted with many types of technology for the digital display could be used. However, LEDs are bright and readable from a distance, switch or change quickly (for example when the clock display is changing) and do not need a backlight that would use additional current. The microcontroller 230 also provides control signals to the stepper motor 170 through a motor drive circuit 250. The stepper motor turns in one direction or the other depending on the input and drives the gear assembly, shown generically in FIG. 13 as 252. The gear assembly 252 turns the clock hands 110 and 112.

As noted previously, stepper motor is connected to 4 drive transistors. Each transistor acts as a switch and is turned on to select one phase. The motor has a total of 4 phases. To activate the motor to move clockwise, the steps are activated in the desired order, and to move counterclockwise, the phases are activated in the reverse order. Each phase, when selected, is powered continuously for a time varying between 4 and 16 milliseconds. The phase may be powered longer, but in the interest of saving power, it may be turned off after 16 milliseconds. The permanent magnet stepper motor remains at each detent position once power is removed, unless the detent torque is exceeded. In the present example, the “counter” torque is low, as it is only the back-torque of a gear train, which is lower than the detent torque of the motor. The stepper motor may alternatively be driven by drive current controlled by an appropriate control logic circuit

In the exemplary configuration, the motor has 48 steps per revolution, or 7.5 degrees per step. The gear train provides a reduction of 5 times for the minute hand, which means that it will take 240 steps to move the minute hand around one rotation, or 1 hour. In other words, there are 4 steps per minute or one-step every 15 seconds. The hour hand is geared down 60 times from the motor shaft, so that it will have the desired 1:12 ratio to the minute hand. The reduction is done with the 5 gears identified. The gearing also reduces the detent torque requirement for the motor.

The exemplary stepper motor system is an open loop system, with no positional feedback to the controller. Positional feedback is not necessary in the working mode, but it is useful for the first power up or reset or after a power loss. Therefore, the clock hand positions are calibrated to the known position before beginning normal operation. The known position is that configured on assembly to correspond to the controller settings, in the present example the positions at 12:00 corresponding to the controller memory or counter settings for that time setting. As noted previously, the calibration is carried out in the exemplary configuration by the two optical sensors, for setting the clock hands at the 12 o'clock position on initial power up. The microcontroller moves the clock hands to this calibrating position once and after calibration the optical sensors are turned off until the next calibration, because as long as battery or AC power is applied and the reset button is not activated, the microcontroller tracks the movement of the hands from the original hand positions. Turning off the optical sensors also saves energy. It should be noted that it is preferred not to put a photo-interrupter on the minute hand reduction gear, and the photo interrupter on the stepper motor output shaft provides better calibration accuracy, because the motor is geared down by a factor of 5 to drive the minute hand.

The motion achieved by the stepper motor could be accomplished with a standard motor, such as a DC “brush” motor, which for example may be desirable for small bedside clock. A brush motor could include a worm on its shaft, and then interface it to a worm gear. The motor/ worm/ worm gear combination could then take the place of the stepper motor, and the back-torque of the worm gear reduction would approximate that of the detent torque of the stepper motor in this application. However, an optical encoding system may be necessary with a brush motor coordinated with the output shaft, allowing the control electronics to track the position of the shaft. Additional drive electronics may also be used, in order to drive the system correctly in small increments and at various speeds, and there may be more software load on the microcontroller.

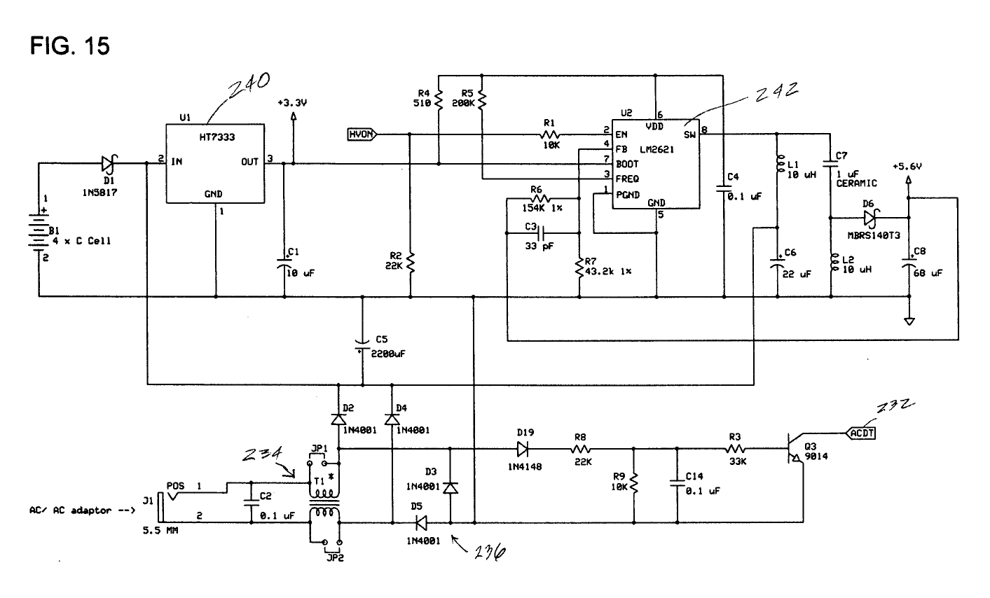

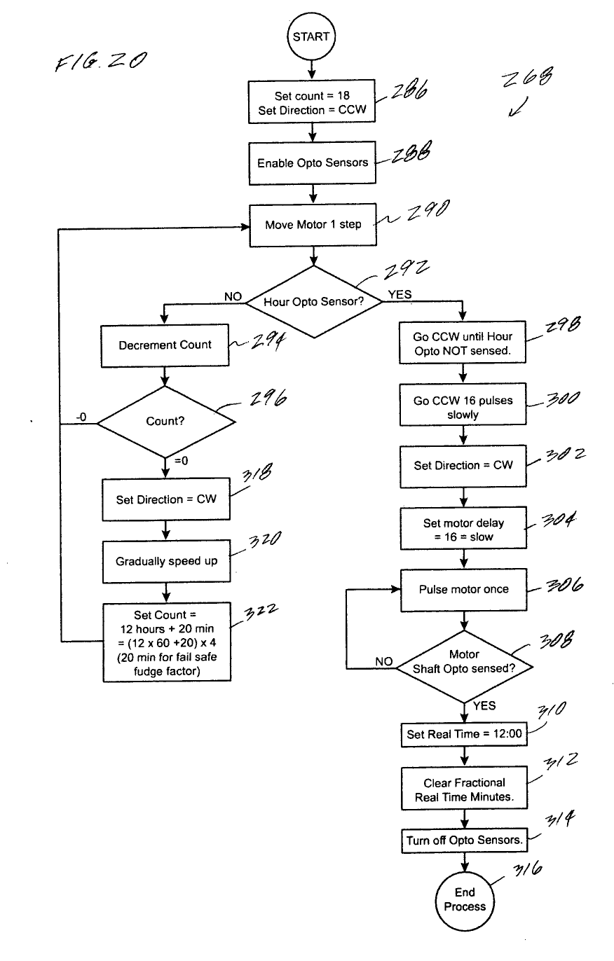

A system for controlling one or more displays is depicted in FIG. 14. The system in FIG. 14 represents a clock having two displays as part of a display component 254. The display includes mechanical clock 104 and the digital clock 106. The display 254 is controlled in part by user input 142, part of which may be a switch 142A to turn the digital clock on and off. The remainder of the components of the system include power input components 256, control components 258 and interface components 260. As shown in FIG. 14, the control components 258 may include a conventional microprocessor, a controller or internal clock, a comparator and a memory unit. As represented in FIG. 14, the control components control both the analog display and the digital display. As a result, the two displays can present the same information substantially simultaneously, for example in different modes or formats. In so doing, the displays are effectively synchronized. Additionally, the user inputs can be accepted by one component assembly, such as the control components, and the results of the input applied to both of the displays simultaneously. Therefore, in the present example, input is to a digital device such as the controller, which then uses the input to control an analog device and/or another digital device, and in the in the present examples, both. The characteristics of the control components 258 will be better understood by a considering an exemplary process in conjunction with the flow chart of FIG. 19.

As an overview, the microcontroller includes firmware stored in memory and executable during operation. At the start of the firmware program, the clock will begin to calibrate itself to 12 O'clock. The controller first moves the hands counter clockwise 10 minutes, just in case the clock was recently calibrated, and the hands are near the 12 O'clock position. The sensors are enabled and looking for the hour position sensor to detect the opening on the hour gear. As noted previously, a clear hour gear with a dark spot or line at the 12 O'clock position could serve the same purpose, as long as the sense was inverted in the program.

If the hour sensor is not located after going counter clockwise for 40 pulses (10 minutes) the program starts to move the motor in a clockwise direction for up to 12 hours (12 hours by the hands, as opposed to 12 hours elapsed time). When the hour sensor is located, it is an approximation for where the real 12 O'clock position is. It is noted that the hour gear gives only an approximate reading because it is at the end of a gear train, which is subject to wider tolerances (“slop”) and uncertainty. In the present example, the hour gear identifies the position to within plus and minus 6 minutes.

After the hour hand has approximately located the 12 O'clock position, the motor is sent back in a counterclockwise direction until the hour sensor is no longer reading, and a little farther. Then the motor begins to move clockwise. This time, the controller looks at the motor shaft sensor, and the motor moves until the motor shaft opto-interrupter module is interrupted by the leading edge of the position indicator 176. The advantage of precisely identifying the position with the motor shaft is that it is accurate to ¼ minute, and there is little or no gear slop or backlash to contend with. Both sensors are not monitored at the identical same time because gear slop may lead to the two sensors not actually coinciding when the hands reach the exact 12 O'clock position. Therefore, calibration is improved even with gear slop. Additionally, the motor shaft sensor detects only the leading edge of the position indicator 176 when the minute hand is moving in the clockwise direction, when viewing the clock face, so that the width of the indicator is not a factor in the calibration, and because sensing the leading edge of the position indicator when moving counterclockwise could introduce an error to the extent of the width of the position indicator.

When the calibration is complete, the microcontroller begins to scan the buttons, switches, and rotary time-set switch to see if any actions are being input by the user. When the user selects an action, the microcontroller will begin to execute the corresponding code.

In addition, in a background interrupt routine, the chip begins to keep track of the real time, as the real time clock portion of the chip will interrupt the microcontroller. Every 15 seconds, the real time is incremented, allowing the clock to keep time with a resolution of 15 seconds. Every 15 seconds, if the clock hands are not busy doing some specified action (such as in the demo mode), and if the working mode is selected, the hands will move forward by one-step. Every 4 steps, the hands will be seen to arrive at a full minute mark 118 (FIG. 1), and the LEDs will be updated to the next minute, assuming the control switches (knob 156) are set to turn on the LEDs. If the clock was in demo mode, the hands and the LEDs will not update until the clock is returned to the working mode. If at a later time the clock is put back into working or clock mode, the microcontroller will calculate how many steps, and in the closest direction, it must move the hands and change the LEDs to return them to the correct real time. Note that the most the hands will have to move will be 6 hours worth of a sweep, because of the ability to move bidirectionally and because the microcontroller can choose the most efficient direction of motion. In the present examples, the LEDs will always match, and move at the same rate as, the clock hands.

If the user presses the “Time advance 30 minutes” for example, the controller will move the clock hands clockwise for 30 minutes * 4 pulses/minute =120 pulses. Various algorithms and tables can be used to instruct the controller how many milliseconds to allow to each step. In general, a contour system is used, so that the first few pulses each take 8 milliseconds, but as the motor begins to build up momentum, the pulses gradually decrease to 4 milliseconds. When the hands have moved halfway to their destination, the reverse contouring is used. Contouring operates the motor conservatively so that it does not malfunction or slip a step due to the pulse being too short, and it gives the appearance to a human observer that seems natural. If all of the pulses were 8 milliseconds, for example, the motion would appear to be plodding along, and would not be as pleasing to the eye. Contouring helps to make the product easy to interact with.

A similar contour approach is used with the rotary time set knob 156. If the knob is rotated either clockwise or counter clockwise to the first position (A1 or R1), the program begins to move the hands at a very slow speed, and gradually increases the speed up to a certain speed. If the user moves the knob in the same direction to the second position (A2 or R2), the speed increases at a faster rate up to a final speed of 4 milliseconds, with no gaps between pulses. If the user then moves the knob back to the lower position, or to the middle position, or to the reverse direction, the algorithm will decide what to do. If the hands had been moving at top speed, the controller will decelerate the hands for a few pulses until a safe stopping speed is reached. Then it will go back to the maximum slow speed, or stop, or begin to move in the reverse direction, depending on the new setting of the rotary switch. With these variations, the user is more likely to feel like the clock motions are natural and “real.” In other words, the system operates with acceleration and deceleration, which may be expected in working with time keeping devices and other displays.

Even though moving the hands was done over a number of pulses, for example 120 pulses to move 30 minutes, the actual number could be slightly different. For example, in the clock or working mode, the clock keeps a resolution of ¼ minute which gives a natural analog look to the hands, but having the hands jump from minute to minute (in one minute incremental movements) the movement may be distracting. However, when the user desires to move the hands, it is too tedious and does not give any advantage to move the hands in ¼-minute increments. Therefore, in the demo mode when a jump button is pushed, for example, the controller moves the minute hand fractional minutes to an even minute, thereby removing the fractional minutes, and thereafter moves the minute hand full minutes of 4 pulses after that. In other words, generally, except for the first fractional minute, the hands move in groups of 4 pulses, when moved by the user. If the LED displays, for example, 12:33, but in reality the time is 12:33 and (because the LEDs display the time only to the minute without any fractional display, in the present example, even though seconds or fractions thereof could be displayed if desired), and the minute hand is at the position corresponding to 12:33 and ¼, then in order to advance 30 minutes, the controller moves the stepper motor 128 pulses instead of 130, so that the LED time will advance 30minutes, and the minute hand will be exactly “on” a minute mark.

A number of power saving features are included in the program and hardware, since the product may operate from batteries. If the AC adaptor is plugged in to the junction 140, the microcontroller will be able to tell from the input labeled “ACDT.” In this case, all power saving features are disabled. If the clock is operating from battery power, it will turn off the LED display after a substantial period of inactivity. Inactivity is defined as a period with no user input. When it shuts off the LEDs, the microcontroller will continue to keep time, and will continue to move the hands by one-step every 15 seconds, if the clock is in working or Clock Mode. Once per hour, it can flash the LED display to remind the user that it would be a good idea to return it to AC power. As noted previously, the LEDs consume power and could drain the batteries in a few hours, if the LEDs are left on.

If any buttons or switches are pressed while the unit is in the power-down condition, it will immediately wake up, turn on the LED display (if enabled by the switches) and begin to process the user request as if nothing was asleep. This is accomplished through careful circuit design to make sure that any movement on any of the inputs will wake up the chip.

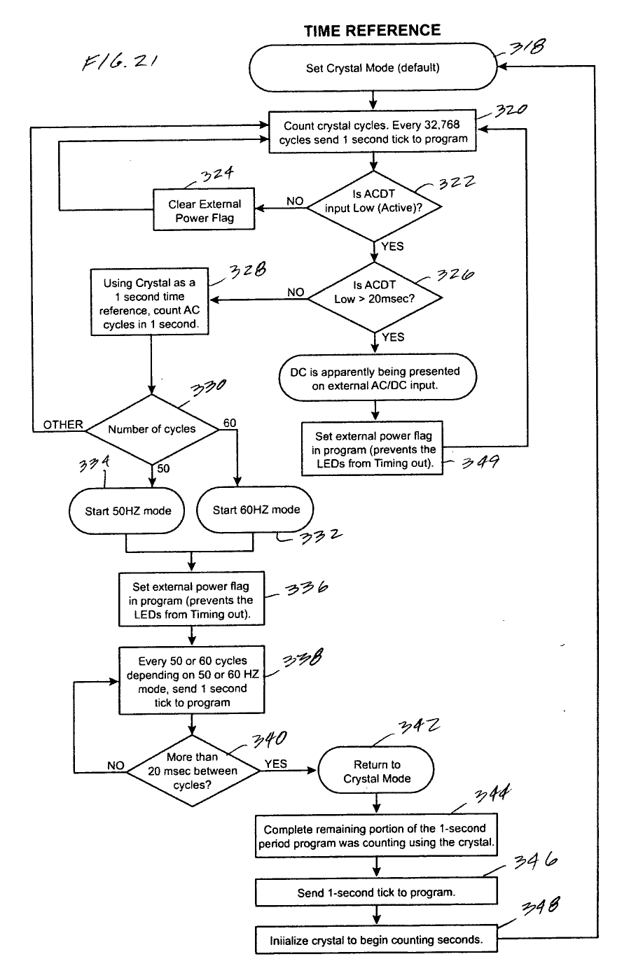

Considering the system in more detail with respect to the flow charts of FIGS. 19-28, the system of the present presentation or display device in the form of the clock 100 begins or restart operation when power is applied 264 (FIG. 19), or when the system is reset. The microprocessor initialize is the variables 266, and then begins a calibration procedure 268. The calibration procedure is described more fully below with respect to FIG. 20. After calibration, the optical sensors 178 and 200 are turned off or disabled and a microprocessor time is set 270 to 12:00 by setting the seconds, minutes and hours counters to zero. The system then operates normally until another calibration event occurs.

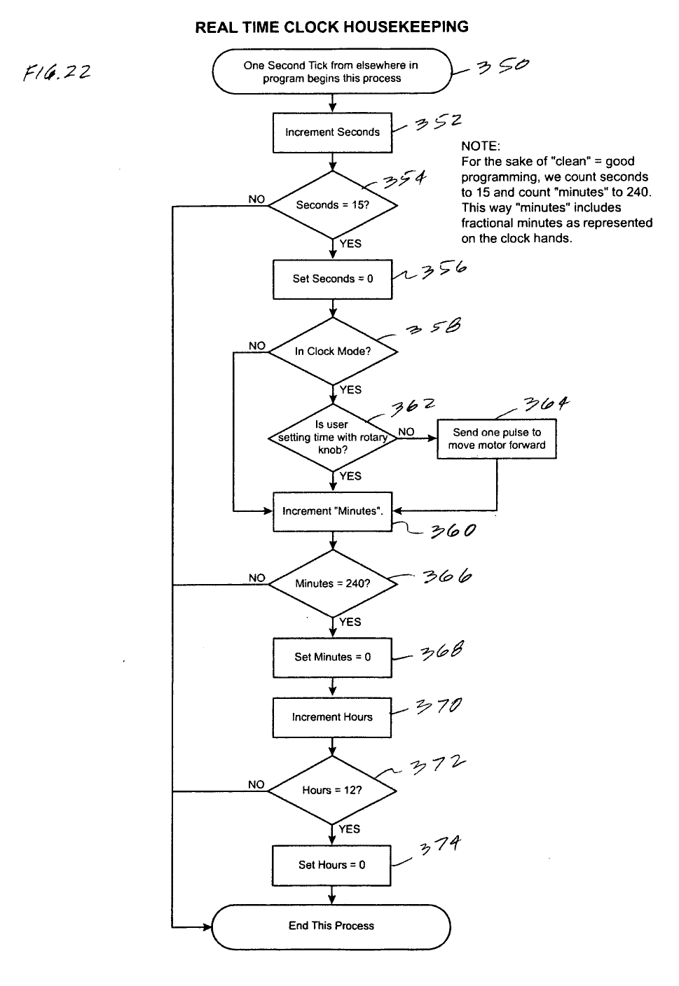

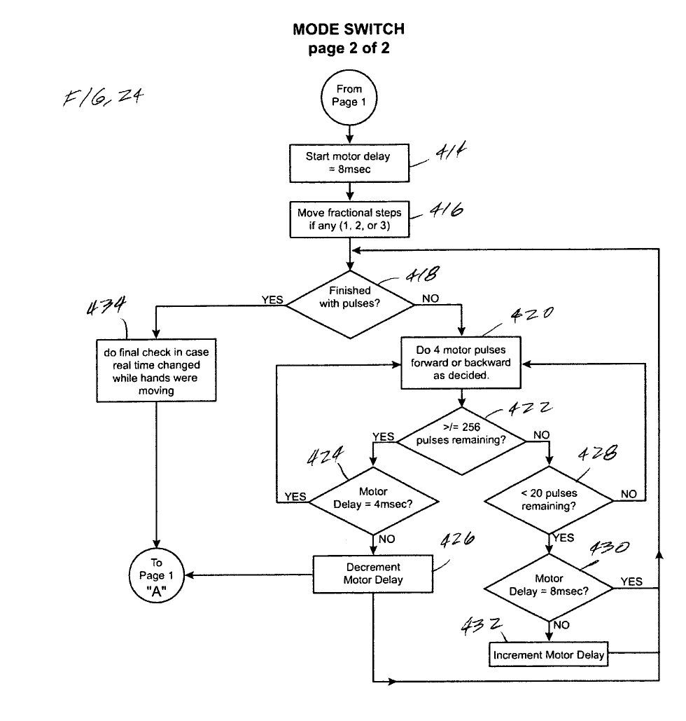

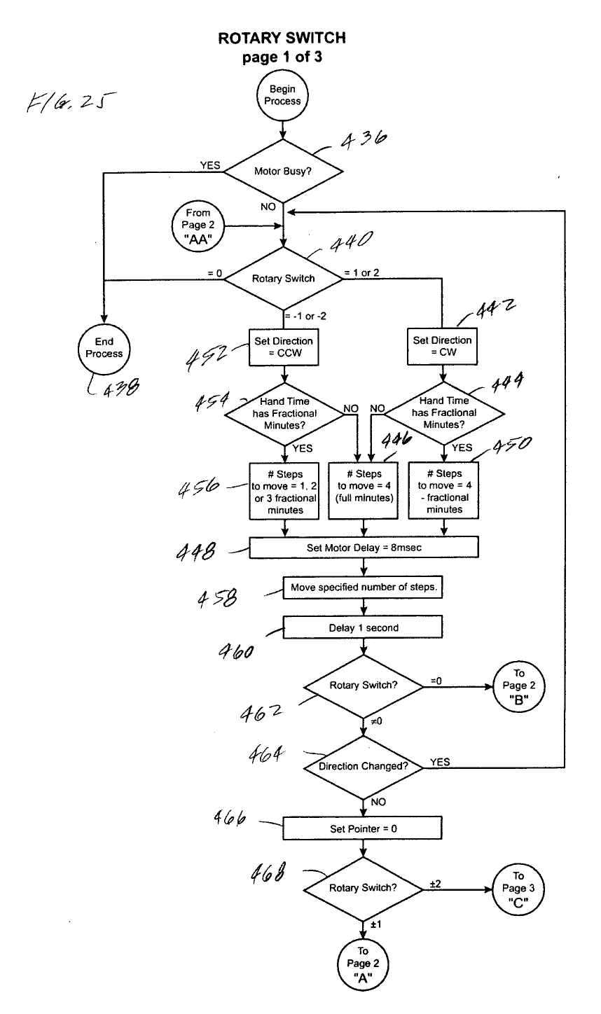

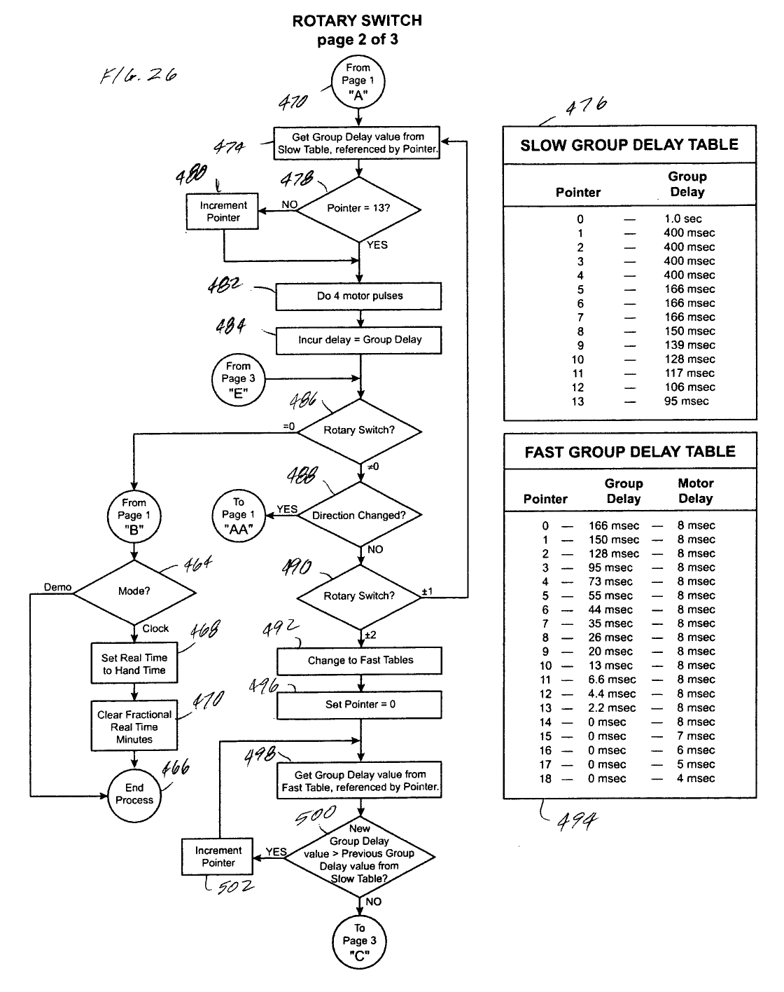

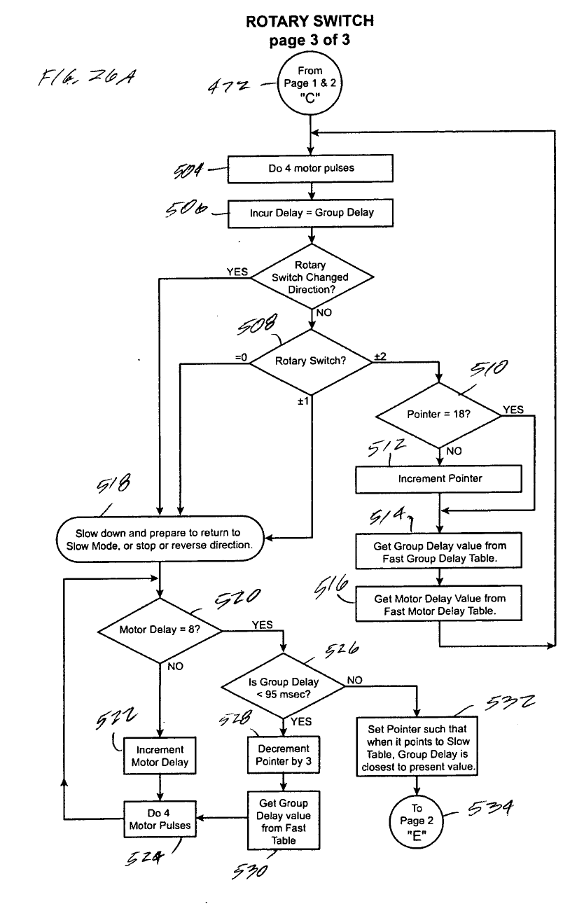

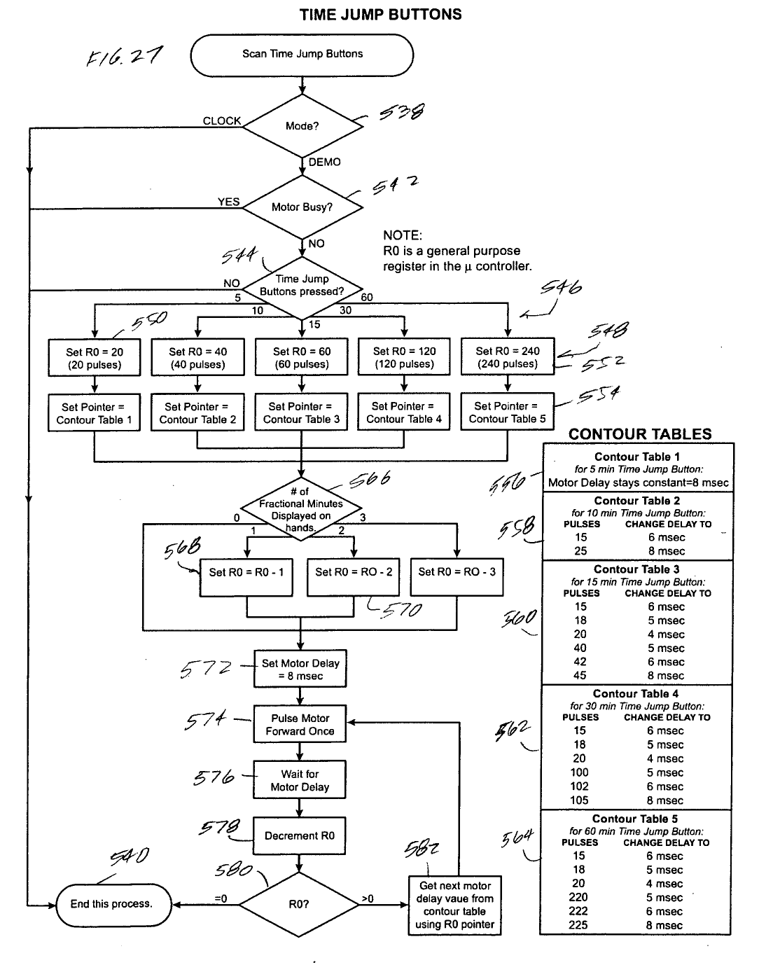

The system then follows a main program loop 272 until power is removed or until the system is reset. The beginning of the cycle of the program loop starts with determining the time reference 274 to be used by the microcontroller in keeping time and in displaying the correct time during the working mode. Determining the proper time reference is described more fully below with respect to FIG. 21. The system then checks 276 the elapsed time and updates the seconds, minutes and hours counters. Thereafter, the system scans the user input elements for changes requested by the user. Specifically, the system scans 278 the mode switch 144 to evaluate the mode switch status. Scanning and operation according to changes in the mode switch are discussed in more detail with respect to FIGS. 23 and 24. The system then scans 280 the rotary knob 156, as described in more detailed below with a spec to FIGS. 25 and 26. The scan knob switch 156 is checked 282 for its axial position to determine if the digital display should be on or off. If the knob 156 is pressed in as shown in FIGS. 6 and 8,the digital display will be illuminated by applying power to the LED's 120. If the knob 156 is pulled out, to the position shown for example in FIG. 7, the digital display will be turned off by removing power from the LED's 120. The system then scans 284 the user input push buttons 146-154 to see if any of them have been actuated. The actuation and operation as a result is discussed in more detail with respect to FIG. 27. Before returning to restart loop, the system checks 285 the status of the LED's. If the clock is operating on battery power and no user input has been received for a predetermined time, for example five minutes, eight minutes, 10 minutes or other selected time interval, the LED's are turned off. However, while under battery operation with the LED's turned off, the system can flash the colon LED's periodically or randomly to let the user know that clock is under battery operation, and a power adapter should be plug-in to conserve the batteries. Line power would also allow the controller to synchronize with the incoming AC frequency. After checking the status of the LED's, the system returns to restart the operating loop.

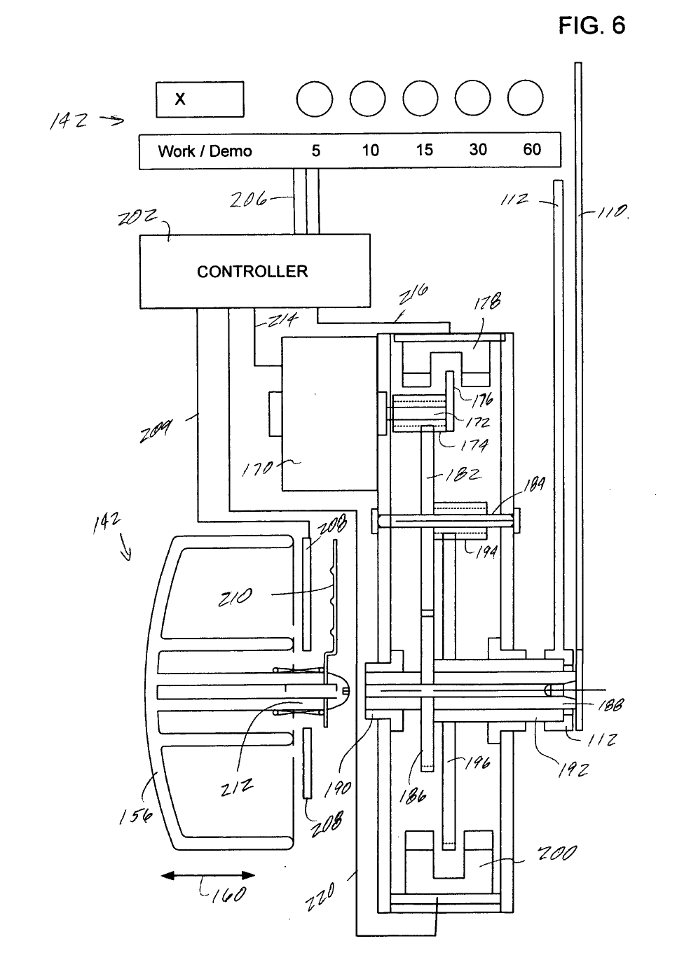

During the calibration steps (FIG. 20), a motor step counter is set to 18, and the motor direction is set to counterclockwise 286. The optical sensors are then enabled 288 and the motor is moved one step 290 counterclockwise, and the system checks 292 if the hour optical sensor 200 senses the opening 198 in the gear 186 (FIG. 4 and 5). If not, the counter is decremented 294 by one, and the counter value checked 296. If the motor has not moved the minute hand 18 steps (approximately four and ½ minutes arc), the system returns to move the motor another step 290. If after moving the motor counterclockwise 18 or fewer steps results in the hour optical sensor 200 going high or positive indicating the opening 198 is aligned with the optical sensor 200, then the minute and hour hands are relatively close to 12:00. Then, the motor is moved 298 car clockwise until the hour optical sensor goes low or negative indicating that the opening 198 is no longer aligned with the optical sensor 200. The motor is moved counterclockwise 16 pulses 300 slowly to move the minute hand over an approximately four minute arc counterclockwise. The minute hand should then be counterclockwise of the “12”. The system then sets 302 the motor direction to clockwise and sets 304 a motor delay variable equal to 16, which will be taken as “slow” for this calibration movement. The motor is then pulsed or moved one step 306 and the system checks 308 to see if the leading-edge of the pointer 176 (FIG. 5) has broken the beam of the optical sensor 178. If not, the motor is pulsed again 306 until the pointer 176 is sensed by the optical sensor 178. The clock setting in a microcontroller is then set 310 at 12:00 by setting the seconds, minutes and hour counters to zero. The system then clears 312 any fractional real-time minutes and returns 316 to the main program loop 272 after turning off the optical sensors.

During the calibration procedure (FIG. 20), if the motor moves 18 steps without sensing the hour optical sensor (step numbers 290-296), the counter reaches zero and the system sets 318 the motor direction to clockwise, starts moving the motor and increasing 320 the motor speed clockwise and sets 322 the motor counter to a value equal to 12 hours and 20 minutes. With the motor counter set, the clock hands will advance to 12:00 before the counter goes to zero. The system will continuously check 292 the hour optical sensor 200 until the opening 198 aligns with the optical sensor 200. The steps 298-316 are then carried out (as discussed above) to set the hands and the controller at 12:00.

To determine and operate according to the correct time reference (FIG. 21), the system by default starts 318 in a crystal mode where the clock crystal 244 (FIG. 13) is used as the clock reference. The system then counts 320 the crystal cycles and every second sends a one second tick to the system. The system then checks 322 if an alternating current signal is being applied to the system by checking the value of ACDT. If the input is high or inactive, the system clears 324 a flag or setting to indicate that external power is not being applied. The system then continues counting 320 the clock crystal cycles.

If an AC signal is detected, the system checks 326 if the AC signal is new by checking if the signal has been applied for less than or equal to 20 microseconds. If so, the system uses 328 the clock crystal as a one second time reference to count the number of cycles received from the AC source occurring in one second. The system then checks 330 if the AC power source is operating at 60 Hz or 50 Hz or some other frequency. If some other frequency, the system returns to continue accounting clock crystal cycles at 320. If 60 Hz, the system starts 332 a 60 Hz mode, and if 50 Hz, the system starts 334 a 50 Hz mode. The system then sets 336 an external power flag, which is used to keep the LED's illuminated. The system then sends 338 1 second ticks to the program every 50 or 60 cycles, depending on the AC input frequency. The system then continues 340 operating in the 50 or 60 Hz mode until AC power is removed, which is determined by there being more than 20 milliseconds between cycles. Thereafter, the system returns 342 to the crystal mode, in which the system completes the remaining portion of the one second period using the clock crystal at 344. The system sends 346 a one second tick to the program and initializes 348 the clock crystal to begin counting seconds. If DC is present through the AC/DC input, when the ACDT signal is low for more than 20 milliseconds (at 326), AC is powering the system, and an external power flag is set 349 to allow the LEDs to remain illuminated.

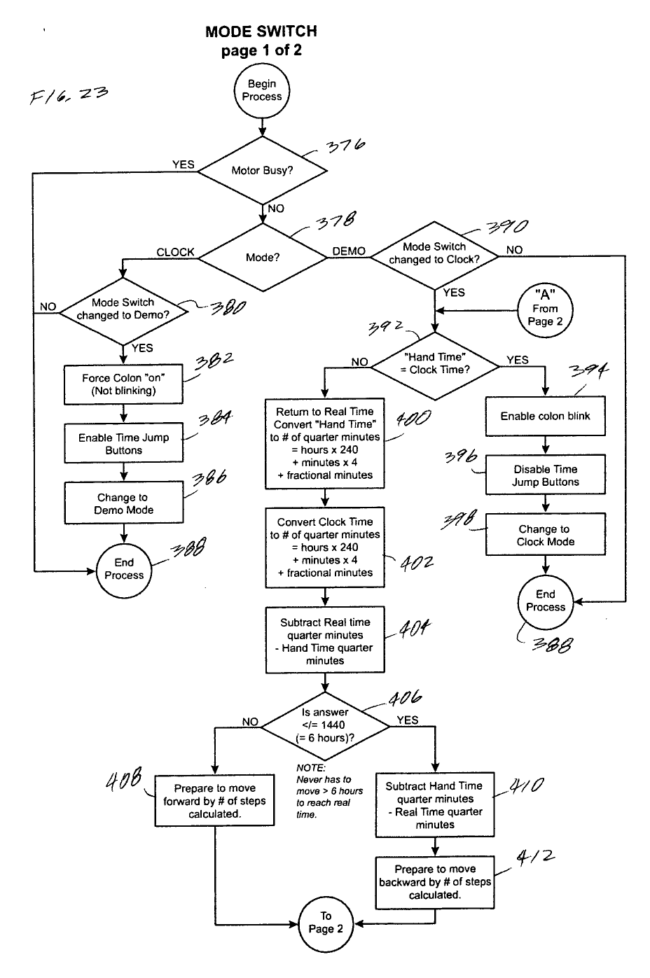

The system keeps a system and counter clock arrangement for keeping track of the elapsed time, as shown in FIG. 22. Specifically, for everyone second tick from the system, represented at 350 the system follows 352 a seconds incrementing process. The system checks 354 if the second counter has reached 15, representing ¼ a minute. If not, the system continues to by exiting the process and continuing to count the seconds ticks until the counter reaches 15. When the counter reaches 15, the seconds are set to 0 at 356. Thereafter, the system decides whether to update the counters and the displays or only the counters. Specifically, the system checks 358 if it is in the clock or working mode, and if not, the system increments 360 the minutes counter without changing the display. If in the working mode, the system checks 362 if the knob 156 is activated and not top center, indicating that the user is setting a time. If the user is setting a time, the system increments 360 the minute counter without changing the display. If the user is not changing the display, the system sends 364 one pulse to the motor to move the motor forward, after which the minutes counter is incremented.

After the minutes counter is incremented, the system checks 366 if the minutes counter has reached 240, or 60 minute increments. If not, the system continues counting one second ticks at 350. If the minutes counter has reached 240, the system sets 368 the minute counter to 0 and increments 370 the hours counter. If the hours counter has not reached 12 the system at 372 continues counting seconds ticks, but if the hours counter has reached 12, the hours counter is set 374 to 0, and the system continues counting seconds ticks.

The system regularly checks the status of the mode switch 144 to see if the mode switch has been changed by the user (see FIGS. 23-24). During its normal loop, the system checks 376 if the motor is busy, and if so, continues its loop without checking the mode switch further. If the motor is not busy, the system checks the system status to see if the system is configured for the clock mode or the demo mode. Specifically, the system checks 378 a mode Is switch or flag. If the system applied is in the clock mode, the system checks 380 if the mode switch 144 has changed to the demo position. If not, the system continues its loop. If the switch position has changed, the system forces 382 the colon LED's to be on, or not blinking, and enables 384 the push buttons 146-154. The system flag is then changed 386 from the clock mode to the demo mode and the system continues 388 its loop.

If the system flag is in the demo mode, the system checks 390 if the mode switch 144 has changed from the demo mode position to the clock mode position. If not, the system loop continues. If so, the system checks 392 if the system needs to update the positions of the hour and minute hands to reflect the current time. Specifically, while in the demo mode, the system has been counting up and down the number of pulses that the motor has moved, either forward or backward, respectively. Then, when the mode switch is changed from demo to working mode, the system checks to see if the clock counter is different from the number of pulses in the “motor counter” that the clock hands moved from the starting time when the mode switch was moved from clock or working mode to demo mode. Therefore, if the counter representing the hand movements has the hand display time the same as the real clock time, the system enables 394 the colon blinking indicating the working mode, and disabled 396 the push buttons 146-154. The system then changes 398 the flag from representing demo mode to representing clock mode or working mode. The system loop then continues.

If the system finds during its check that the hand time display does not match the real clock time, the system changes the display to match the real clock time for the working mode. To do so, the system converts 400 the counter values representing the current time display of the hands to the number of quarter minutes. Specifically, the system multiplies the number of hours by 240, adds the product of the number of minutes and 4, and adds the units representing any fractional minutes. The system does the same conversion 402 to convert the real clock time. The two values are subtracted 404, and if the difference is greater than 1440 (the equivalent of six hours of quarter minutes), the hands can be advanced more quickly to display the correct time than if the hands were reversed. The system then prepares 408 to move the hands forward (sometimes herein labeled as CW) by the number of steps represented by the difference calculated in 404. If the difference is less than or equal to 1440, the value of the real-time in quarter minutes is subtracted from the value of the hand time quarter minutes at 410, and the system prepares 412 to move the hands backward by the number of steps represented by the difference calculated in 410 by setting the motor direction to counter clockwise (sometimes herein labeled as CCW). In this way, the clock hands can be moved to the correct time display through the shortest possible sweep.

Specifically, as shown in FIG. 24, the system sets 414 a motor delay to 8 milliseconds and then moves 416 the motor any fractional steps so that the minute hand aligns with a minute mark 118 (FIG. 1). If the difference values determined from either 404 or 410 (FIG. 23) are nonzero (418), the motor is pulsed 420 in the designated direction (clockwise or counterclockwise), and the pulse count needed to get the clock hands to the correct display time is decreased by 4. The system then checks 422 if the number of pulses remaining is greater than or equal to 256. If so, the motor delay setting is checked 424 to see if it has been decreased from eight milliseconds to four milliseconds. If not, the motor delay setting is decreased 426 because there is enough time left in the movement of clock hands to increase the motor speed to move the clock hands faster. The system then returns to pulse 420 the motor four more pulses through the query 418. Conversely, if the motor delay setting equals four milliseconds, as determined at 424, the system returns to continue pulsing the motor at 420. The system designer can set the motor delay to be incremented or decremented more or less than 1millisecond as desired.

As the motor continues moving, and the hands get closer to the correct time display, the pulse count becomes less than 256. If there are 20 or more pulses remaining 428, the system returns and pulses the motor 420 four more pulses and continues. If there are less than 20 pulses remaining at 428, the motor delay is checked 430. If the motor delay is less than eight milliseconds, the motor delay is incremented 432 to slow the hand movement and the system checks 418 the pulse count, and the system continues. If the motor delay is eight milliseconds, meaning that the clock movement has slowed, the system returns to check if the pulse count has reached 0, at 418. If not, the system continues until the pulse count reaches 0, at which time this system does a final check 434 to see if the real clock time has changed while the clock hands were moving. Therefore, the system returns to compare the hand display time with the actual clock time at 392 (FIG. 23), and the system continues.

During the loop processing, the controller also scans and processes user input from the rotary switch knob 156. At the beginning of the process (FIG. 25), the system checks 436 if the motor is busy, and if so exits 438 monitoring and returns to the main loop. If not, the system checks 440 the position of the rotary switch knob 156. If the position is positive corresponding to A1 or A2 (FIG. 2), the system sets 442 the motor direction flag to clockwise (CW), and checks 444 to see if the then-existing hand time display has any fractional minutes (FIG. 25). If not, the system sets 446 the number of motor increments to 4 pulses (corresponding to a full minute) and sets 448 a motor delay value to 8 milliseconds. Conversely, if the hand time display has fractional minutes, in other words is between minute marks 118 (FIG. 1), the motor is set 450 to move a number of steps equal to that needed to move the minute hand to the next minute mark, namely 4 minus the number of pulses representing the fractional minutes. The motor delay is then set 448 to 8 milliseconds.

If the knob 156 position is negative corresponding to R1 or R2 (FIG. 2), the system sets 452 the motor direction to counterclockwise (CCW). The system checks 454 to see if the then-existing hand time display has any fractional minutes, and if not, the system sets 446 the number of motor increments to 4 pulses. The system then sets 448 the motor delay to 8 milliseconds. Conversely, if the hand time display has fractional minutes, the motor is set 456 to move a number of steps backward sufficient to align the minute hand with a minute mark. The number of pulses equals the number of quarter minutes the minute hand is beyond the preceding minute mark. The system then sets the motor delay at eight milliseconds.

After the motor delay is set to eight milliseconds, the motor is moved 458 the specified number of steps, and the motor delayed 460 1 second. The system then checks 462 to see if the rotary switch knob 156 in the interim has been reset to top center, and if so the system checks 464 if the mode value corresponds to demo mode, in which case the system returns to the main loop at 466. If the mode value corresponds to clock or working mode, the system sets 468 the real-time counters in the controller to the values represented by the hand time display, meaning that the user has changed the clock setting after a suitable delay to ensure that the user is done changing the display time. The system then clears 470 any fractional real-time minutes in the counters and returns to the main loop.

If at 462 (FIG. 25) the rotary switch knob 156 is other than top center, the system checks 464 to see if the knob position is on a different side of top center (moved from A1 or A2 to R1 or R2, or vice versa) than the immediately preceding stored value in the controller corresponding to the rotary switch knob 156 setting, the system returns to check 440 the position of the rotary switch knob 156. If the knob direction has not changed from the previous side of top center, the system sets 466 a pointer equal to 0. The pointer will be used to either up or slowdown the display change speed while the knob 156 is actuated. As noted above, when the knob is at the slow moving positions of A1 or R1, the hands and digital display change more slowly than when the knob is at the fast-moving positions of A2 or R2. The pointer is used to identify a delay in pulsing the motor as a function of whether the knob 156 remains in its position or if the knob has been moved to a different knob position, and what the knob position is. During this processing, the displays can be made to have a relatively smooth and natural appearing motion as the displays are changing.

The processor at 468 determines whether the knob 156 is set at a slow change speed or a high change speed. Specifically, if the rotary switch knob 156 is set to a slow speed, represented by A1 or R1, the controller moves to 470 (FIG. 26), and if the rotary switch knob 156 is set to a high-speed, the processor moves to 472 (FIG. 26A). If the switch knob 156 is at a slow speed, the system retrieves 474 a group delay value from a slow group delay table 476, and evaluates 478 the current value of the pointer. If the value does not equal 13, the pointer is incremented 480 and the motor is moved 482 four pulses in the direction determined by the motor direction setting (CW or CCW). It should be noted at this point that a motor delay is imposed on the motor after each pulse, and unless otherwise set at a different value, the motor delay is typically eight milliseconds. However, where the motor speed and the speed of display change is to be increased, the motor delay will be changed from eight milliseconds to a smaller delay, for example as small as four milliseconds, or the delay can be as high as one second in the examples described herein. Other delay values can be adopted, but the delay values discussed herein are used in the present example. The motor delay is provided to account for the mechanical inertia of the stepper motor and the acceptable pulse rate for the motor. The phrase “motor delay” will refer to delays between single pulses, while the phrase “group delay” will refer to the delay time after each group of 4 pulses or after less than 4 pulses for fractional minutes. In the present examples, the range of motor delays is 4-8 milliseconds while the range of “group delays” is 0-1 second. As seen in the slow group table 476, the delay between groups of four pulses ranges from one second down to 95 milliseconds. Therefore, the minute hand moves slowly with an eight milliseconds delay between each single pulse and a one second delay between each group of four pulses, so that the user may see a noticeable pause in minute hand movements from one minute position to the next. When the group delay is 95 milliseconds, the pause between minute hand movements from one minute position to the next may not be as noticeable.

After the four motor pulses 482, the system delays 484 the motor an amount equal to the group delay determined by the pointer value in the slow table 476. The system then checks 486 if the rotary switch knob 156 position has changed, and if it has changed to top center, the system checks the mode setting at 464 (FIG. 25A) and continues processing. If the rotary switch knob 156 is other than top center, the system checks 488 to see if the rotary switch knob 156 position has moved from one side of top center to the other side. If so, the system returns to check 440 the rotary switch position (FIG. 25) and continues processing. The system then checks 490 to see if the rotary switch knob 156 is still a slow speed setting or has moved to a fast speed setting. If the knob 156 is on the same slow speed setting, the system retrieves 474 the group delay value from the slow table 476 and checks 478 the pointer value. Conversely, if the knob 156 has changed to the fast speed, the system changes 492 to a fast table 494 and sets 496 the pointer to 0.

The system then retrieves 498 the group delay value from the fast table 494 corresponding to the pointer value. The system checks 500 if the new group delay value from the fast table 494 is greater than the previous group delay value from the slow table 476. If so, the system increments 502 the pointer and retrieves 498 the new group delay value from the fast table 494 and continues processing. If the new group delay value is not greater than the previous group delay value from the slow table, the system moves to the fast speed at 472 (FIG. 26).

At a fast changed setting of the rotary dial switch 156, the system applies 504 for pulses to the motor and then delays 506 the motor by a value equal to the group delay from the fast table 494 corresponding to the particular pointer value. The system then checks 508 the then-existing rotary switch knob 156 position against the last known value for the rotary switch setting to see if the user has changed the knob position. If the knob is still set at the immediately preceding, fast position, the system checks 510 if the pointer is set at 18. If not, the pointer is incremented 512 and the system retrieves 514 the group delay value from the fast group table 594 corresponding to the new pointer value. If the pointer value equals 18, the system retrieves 514 to group delay value and also retrieves 516 the motor delay value from the fast table 594 corresponding to the then-existing pointer value. The system then applies for motor pulses at 504 and continues processing.

If the system determines at 508 that the rotary switch knob 156 has changed, either to the other side of top center or to the slower setting in the same direction, the system proceeds to slowdown the motor and clock hand movements at 518 (FIG. 26B). The processing after 518 prepares the system to return to a slow mode or to stop, or to reverse direction. Specifically, the system determines 520 if the motor delay is eight milliseconds, and if not, increments 522 the motor delay. The system then applies 524 four motor pulses, and checks 520 the motor delay value again. The system then continues processing. When the motor delay equals eight milliseconds, the system checks 526 the group delay to see if it is less than 95 milliseconds. If so, the system decrement's 528 the pointer value by 3 and retrieves 530 a new group delay value from the fast table 594. The system then applies for motor pulses and re-evaluates 520 the value of the motor delay, and continues processing.

If the group delay is not less than 95 milliseconds, the system sets 532 the pointer value such that wind it points to the slow table 476, the retrieves group delay is closest to the then-existing value of the group delay. The system then proceeds 534 to again check 486 the rotary switch position (FIG. 26) and continues processing.

If the mode switch corresponds to the demo mode and the rotary switch knob 156 is moved from top center, the push buttons 146-154 are disabled.

When the system in the main loop scans 536 the time jump push buttons 146-154 (FIG. 27), the system determines whether the user has activated a button corresponding to a preset advance. The system first checks 538 the mode condition of the controller, and if in the clock mode the controller returns 540 to the main loop. If the controller determines the mode condition is the demo mode, the controller checks 542 to see if the motor is operating, and if so exits 540. If the motor is not busy, the system checks 544 to see if any of the time jump buttons, and if not exits 542 the main loop.

If one of the time increments buttons has been pressed, the system determines 546 which button has been pressed and sets 548 a register in the microcontroller with the value of the number of pulses required for the motor to move the selected number of minutes or other incremental value for the display. For example, where the user has selected the push but 146, the register is set 550 with a value representing 20 pulses, corresponding to 5 groups of four pulses each to move the minute hand 20 quarter-minute increments. If the push button 154 is pushed, the system sets 552 the register with a representation of 240 pulses to move the minute hand over a one-hour sweep. The system then sets 554 a time jump pointer to a value corresponding to the push button that was actuated. When the time jump button actuated is push button 146, the pointer value points to contour table 1 at 556, and when the time jump button is push button 148 the pointer value points to the contour table 2 at 558. When the time jump button is push button 150, the pointer value points to contour table 3 at 560, when the time jump button is push button 152, the pointer value points to contour table 4 at 562, and for push button 154, the pointer value points to contour table 5 at 564.

After setting the pointer, the system checks 566 the number of fractional minutes displayed on the clock hands, and adjusts to motor pulses to have the minute hand end up on a minute mark. Specifically, if the clock minute hand is positioned ¼ minute beyond the last-minute mark, the appropriate register value is reduced 568 by 1. If the clock minute hand is positioned two quarter minutes past the last minute mark, the number of motor pulses is reduced by 2, and likewise with three quarter minutes. The system then sets 572 the motor delay equal to eight milliseconds and pulses 574 the motor forward one pulse. The system then waits 576 one motor delay period and decrement's 578 the register value of the number of motor pulses remaining to move. The system then checks 580 whether the clock hands have moved the full increment. If so, the register value is 0 and the system exits 540. If not, the system accesses 582 the contour table determined by the pointer value and retrieves the appropriate motor delay for the next pulse. If the pointer points to contour table 1, corresponding to the five-minute increment button, the motor delay remains eight milliseconds for all pulses. If the push button activated was the 10 minute push button 148, the motor delay is eight milliseconds for the first 15 pulses, and for the sixteenth through 25th pulses the motor delay is six milliseconds, and thereafter the motor delay returns to eight milliseconds. In other words, for the register value of 40 through 25, the motor delay is eight milliseconds, from 24 through 15 the motor delay is six milliseconds and from 14 to zero the motor delay is eight milliseconds. This process moves the clock hands (and changes the LED's display if they are on) at a first slow speed, then faster, and then slower again as the minute hand approaches the end of the 10 minute increment sweep. Similar comments apply with respect to the ramp up of the clock hand speed for contour tables 3-5. In these examples of the actuation of the push buttons for pre-set incremental movements of the displays, longer movements are accelerated after an initial starting period and then decelerated when the clock hands approach the end of their advance. The clock hand motions then continue until all of the motor pulses have been applied. The speed changes and variations allow the clock (or other presentation of display device) changes to appear natural and less distracting to a viewer.

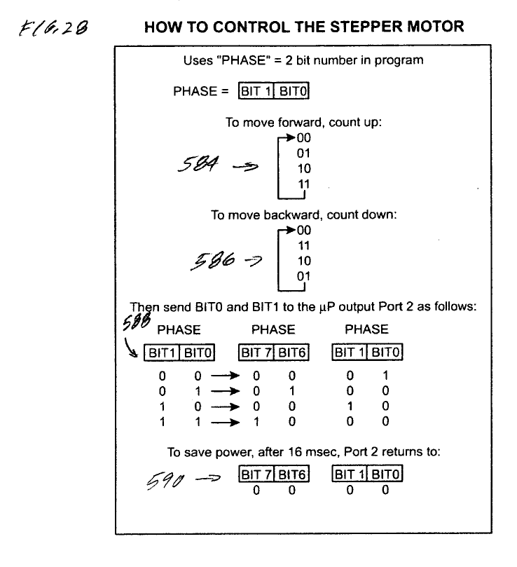

The stepper motor 170 is controlled by the controller using the bit configurations shown in FIG. 28. To move the motor in the forward direction, the binary bit pair are incremented 584, and to reverse the motor, the binary bit pair are decremented 586. The output values for the microprocessor output port 2 for the stepper motor are shown at 588 and 590.

Various alternatives could be used in a display device such as that described herein. For example, an optical interrupter for the optical sensors could be a wire imbedded in or otherwise reliably positioned on one of the gears or on one of the shafts, with the optical sensors appropriately positioned to sense the presence of the interrupter. The sensors could be magnetic, capacitive or other types of sensors. Additionally, the gears and other components mounted on shafts or other elements that need to move but still be fixed relative to each other can be secured by key ways, splines, or other reliable engagements. In another example, the gear shafts are shown as being arranged on a line in the gear box (see FIG. 4) with the spacing shown in Table 2. However, the shafts and gears can be arranged otherwise than linearly or serially, while still keeping the gear ratios, shaft spacings and relationship between the hour and minute hands, to display the desired clock movement.

Other configurations for displays may have a changeable or interchangeable clock face. For example, the clock face can present a novelty clock where the numbers progress increasing in a counterclockwise direction. Then, the hands move counterclockwise to sweep the numbers in increasing direction, and the digital display can remain the same. The controller is easily programmable/controllable to handle either or both clockwise and counterclockwise movements, as noted herein. The clock face can also include a 24 hour time convention, and the controller and digital display could be configured to present time information in that mode as well or as an alternative. In another alternative, the clock can be controlled to move the hands backward and to decrement the digital display as a countdown clock. For example, if an event was to occur at 11:00, three hours from the then existing time, the displays could be set to count down from a 3:00 hour setting (starting at the then existing time of 8:00). The digital display could start at 3:00 and count to 0:00 and the analog clock could start at 3:00 and count to 12:00 and display 12:00, 0:00 or the actual event time of 11:00. In a classroom, the clock could be set to count down to lunch or, count down to a holiday starting the day before or at any selected time. This backward or downcounting could be used in a number of applications, including an alarm or sound-producing application. In an alarm application, an annunciator or other sound producing device, or a voice amplifier with a voice or speech chip could be used to announce the alarm or other set times.

As noted previously, the user input push buttons are disabled during the working mode. However, they can be activated for operation in the working or clock mode to select other features, such as a stopwatch mode, a countdown mode, an alarm mode or for other purposes or functions.

The display device described can also be coupled to a speech chip, allowing the system to move the clock hands automatically or according to speech input from the user. It may also permit speech output for testing a child in time-telling proficiency, by moving the hands forward and backward according to a set testing or teaching algorithm or randomly, in conjunction with clock hand movements. In a random arrangement, the clock hands can be moved to a position, the controller would determine the new clock setting and ask the student to say the new time. Speech recognition could then determine the answer and the controller would determine whether or not the answer was correct. In another example, in a teaching mode, the new clock position would be determined and the speech chip would voice the clock position and then repeat the procedure.

Another feature available in software, either through an ISP port or through original installation, would be as a quiz game with or without speech. For example, with speech, the clock could ask the child to set the clock to 12:24 and wait for the child to move the hands to that position. Since the microcontroller always knows where the hands are, it could prompt the child and say, “you are close, just move the minute hand forward by one minute.” Various forms of prompting are possible, made possible by on features of the inventions.

It is also possible to quiz the child in a visual way, with or without speech. The LED display could show a time, for example 10:54. Then it could flash or otherwise indicate that the child should now move the hands to match the time of 10:54. While other configurations of the LEDs had the LEDs always showing the same time as the hands, one configuration for a software feature is to have the LED could show a different time, as in the above quiz example. All the while, the microcontroller knows where the hands are. The LEDs could be made to blink in a specific way so the user would always know it is in a non-real time mode.

Another quiz form can have the hands and LEDs can move around seemingly randomly, backwards and forwards and at different speeds, and then stop, like musical chairs. The child would then have a certain amount of time to decide whether or not the time on the hands matched the time on the LEDs. If the child answers correctly that the times differed, bonus points could be awarded if they can move the hands, using the time-set knob, to match the LEDs. If such a feature was included in a clock that included speech capability, the microcontroller could be the announcer and conductor of the game, and could award points. The points could also be shown on the LED display. The microcontroller is capable of being an excellent source of randomly selected times for these games.

Yet another feature includes a teaching mode that allows the time-set knob to adjust the time on the LEDs while the time on the hands remains constant. This gives the child a different way of looking at the same problem, which may pique their interest.

An additional example has the display device showing a time, for example 10:15 and stating that the student is to travel to another location for 15 minutes, for example to school. The student is then asked to input the new time when the student would be expected to arrive at school, which would be 10:30. Other mathematics oriented problems could be presented or used. The controller could then check the student entry and teach, coach or approve the entry.

Clock positions can be also changed through user input using a remote control 262 (FIG. 13), if desired. The clock could include a suitable receiver module powered by the power supply and coupled to the controller. The receiver module would provide input recognized by the controller as corresponding to the input that otherwise would have come from the user input elements 142, including the mode switch 144, the push buttons 146-154 and the knob 156. The reset input could also be provided through a remote command. The remote with a numeric key pad could be used to enter the time, hit Enter and the clock would move to that time. The remote can also have keys to select stopwatch mode or countdown mode, or various teaching and game modes.

Other forms of remote control are possible. For example, a so-called atomic clock in the form of a radio receiver could be coupled to the clock. The receiver receives time data from a government broadcast and which is then used to synchronize an internal crystal clock to the signal. In addition the incoming signal can be used to synchronize the mechanical hands to the radio signal, having control over the mechanical hands.

Also, it is possible to have a wired as well as a wireless remote control, and a wired or wireless internet connection. With an internet connection, it would be possible to update the time much the same as the “atomic clock.” A simple wired remote could be useful in a classroom situation as it could be very low in cost. In it's simplest form it could plug into the unit and duplicate the buttons and switched on the product, or it could me more complex.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A clock comprising:
a mechanical time display unit;
a digital time display unit;
an input element to be operated by a user; and
a controller between the input element and at least the mechanical display unit configured to control the mechanical time display unit as a function of input from the user to the input element.

2. The clock of claim 1 further including means for keeping time continuously for at least 12 hours.

3. The clock of claim 1 further including a stepper motor configured to adjust the mechanical time display unit based on input from the controller.

4. The clock of claim 1 further including at least one time change button.

5. The clock of claim 4 wherein the at least one time change button includes a first time change button and wherein the first time change button is coupled to the controller so that activation of the first time change button adjusts the mechanical time display unit to display time five minutes different.

6. The clock of claim 5 wherein the first time change button is coupled to the controller so that activation of the first time change button adjusts the mechanical time display unit to display time five minutes later.

7. The clock of claim 5 wherein the first time change button is coupled to the controller so that activation of the first time change button adjusts the mechanical time display unit to display time that is a different time by one of five minutes, 10 minutes, 15 minutes, 30 minutes and 60 minutes.

8. The clock of claim 4 wherein the at least one time change button is positioned on a back portion of the clock.

9. The clock of claim 1 further including a time change control coupled to the controller and configured such that actuation of the time change control changes at least the time displayed on the mechanical time display unit.

10. The clock of claim 9 wherein the time change control pivots.

11. The clock of claim 10 wherein the time change control can move through an arc of no more than 360 degrees.

12. The clock of claim 9 wherein the time change control has a center position and a first side position for moving the time forward on the mechanical time display unit and a second side position for moving the time backward on the mechanical time display unit.

13. The clock of claim 12 wherein the first and second side positions are on opposite sides of the center position.

14. The clock of claim 12 further including a third side position adjacent the first side position for moving the time forward on the mechanical time display unit at a faster rate than the first side position.

15. The clock of claim 1 wherein the controller is synchronized using an AC frequency from an external power supply.

16. The clock of claim 1 wherein the clock is configured to be accurate within one minute per month.

17. A clock comprising:
a clock mechanism: and
a user input coupled to the clock mechanism selectable for advancing the clock mechanism predefined discreet amounts greater than a one minute amount and less than an hour amount.

18. The clock of claim 17 wherein the clock has a clock face and a back portion facing in a direction different from the clock face and wherein the user input is on the back portion.

19. The clock of claim 17 wherein the user input includes a user input for advancing clock at least one of 5, 10, 15, 30, and 60 minute increments.

20. The clock of claim 17 further including a second user input that pivots relative to the clock.

21. The clock of claim 17 further including a second user input configured to change a display for the clock mechanism at two velocities.

22. The clock of claim 21 wherein the two velocities are a first velocity and a second velocity negative relative to the first velocity.

23. The clock of claim 21 wherein the two velocities are a first velocity and a second velocity higher than the first velocity.

24. A clock comprising:
a first coupling element for receiving a battery and coupling a current from the battery to a DC circuit;
a second coupling element for receiving alternating current input;
a converter element for converting alternating current input from the second coupling element to a direct current on the circuit;
a controller; and
an AC circuit for coupling the second coupling element to the controller.

25. The clock of claim 24 further including an AC to DC conversion circuit and wherein the AC circuit is coupled to a portion of the AC to DC conversion circuit and to an AC input to the controller.

26. The clock of claim 24 further including an AC/AC voltage down converter coupled to the second coupling element.

27. A method for controlling a clock comprising:
sensing a progression of a counter in a controller;
storing a value representing a time in a memory location when the counter reaches a value representing an elapsed minute;
substantially simultaneously changing a time indication on a mechanical clock and changing a time indication on a digital clock after the counter reaches the value representing the elapsed minute.

28. The method of claim 27 further including changing a switch setting from demonstration mode to working mode and comparing the value stored in the memory location with a value representing the time displayed on the mechanical clock, and further including adjusting the mechanical clock based on the comparison of the value stored in the memory location with the time displayed on the mechanical clock.

29. The method of claim 27 further including storing a value representing a time in a memory location representing an elapsed time of multiple minutes while a selector is set for a demonstration mode.

30. The method of claim 29 further including adjusting the mechanical clock time indications based on the elapsed time of multiple minutes after the selector is set to a working mode.

31. A method of controlling a clock comprising actuating a circuit to advance a time display on the clock by a predetermined increment greater than a minute but less than an hour.

32. The method of claim 31 wherein the predetermined increment is a first predetermined increment and wherein the method further includes actuating a circuit to advance the time display on the clock by a second predetermined increment also greater than a minute and less than an hour wherein the second predetermined increment is less than the first predetermined increment.

33. The method of claim 31 wherein the time display on the clock is advanced using a stepper motor.

34. A method of controlling a clock comprising:
using a controller to drive a display representing time;
receiving power from an AC power source at a first frequency;
sensing whether the AC power source operates at the first frequency or at a second frequency different than the first frequency; and
operating the controller based on one of the first and second frequency.

35. The method of claim 34 wherein the controller uses the first frequency to operate a controller clock.

36. The method of claim 35 wherein the first frequency is 60 Hz and the controller operates at 60 Hz.

37. The method of claim 35 wherein the first frequency is 50 Hz and the controller operates at 50 Hz.

38. A game comprising a display showing first and second display formats and wherein the first display includes a first changeable portion and wherein the second display includes a second changeable portion, a controller, and further including means for changing the first changeable portion under control of the controller and further including means allowing a user to change the second changeable portion to display a same information as the first display with the first changeable portion.

39. The game of claim 38 wherein the first changeable portion is a pointer.

40. The game of claim 38 wherein the first changeable portion is movable at least one of rotationally and linearly.
